(19) United States
(12) Patent Application Publication
(10) Pub. No.: US 2014/0365158 A1
(43) Pub. Date: Dec. 11, 2014

(54) LASER ULTRASOUND MATERIAL TESTING

(71) Applicant: iPhoton Solutions, LLC, Fort Worth, TX (US)

(72) Inventors: Marc Dubois, Keller, TX (US); Thomas E. Drake, JR., Fort Worth, TX (US)

(21) Appl. No.: 14/300,841

(22) Filed: Jun. 10, 2014

Related U.S. Application Data
(60) Provisional application No. 61/833,277, filed on Jun. 10, 2013.

(51) Int. Cl. G01N 21/17; G01B 11/24; G01B 17/06

(52) U.S. Cl. CPC G01N 21/1702; G01B 17/06; G01B 11/24; G01N 2021/1706; G01N 2201/121; G01N 2201/06113
USPC 702/104

(57) ABSTRACT

A laser ultrasound system may be utilized to test material quality. The laser ultrasound system may generate a laser for application to a material and measure signal generated by the application of the laser to the material. The measured signals may be altered based on correction factors and the quality of the material may be determined based on the altered signals.

### CROSS REFERENCE TO RELATED APPLICATION

This application claims the benefit under 35 U.S.C. §119(e) of U.S. Provisional Patent Application Ser. No. 61/833,277 filed on Jun. 10, 2013, entitled “Laser Ultrasound Material Testing,” which is incorporated by reference in its entirety.

### FIELD OF THE DISCLOSURE

The present disclosure generally relates to measurement using a laser ultrasound system.

### BACKGROUND

Nondestructive testing of materials may allow the quality (e.g., quantitative quality and/or properties) of a material for a particular application to be tested without compromising the later use of the material. Material testing operations may include the use of pulse-echo mode systems and laser ultrasonic measurement systems.

Current laser ultrasonic measurement systems are sensitive to material properties, and so measurement using current laser ultrasonic measurement systems may require modification and/or destruction of at least a portion of the material to obtain proper measurements. For example, a top surface may be manually scuffed, coatings may be removed, etc.

### SUMMARY

Embodiments of the present disclosure may provide a laser-ultrasound system comprising a generation laser beam that generates ultrasonic displacements in a target; a detection laser beam that illuminates the target; an optical and electrical assembly that collects and processes a portion of the detection laser beam that is reflected by the target to produce signals representative of mechanical displacements; and at least one processing unit that records operational parameters during the collection and processing of the portion of the detection laser beam that is reflected by the target, calculates one or more correction factors for each signal using the recorded operational parameters, scales the amplitude of each signal using the one or more correction factors. The recorded operational parameters may include the power of the portion of the detection laser beam that was collected and the electronic gain used to produce the signals. The one or more correction factors may include the product of the power of the portion of the detection laser beam that was collected and the electronic gain used to produce the signals. Calculating the one or more correction factors may include a smoothing by a kernel. The recorded operational parameters may further include the pulse energy of the generation laser beam. The one or more correction factors may further include the pulse energy of the generation laser beam. A correction as a function of the time of the signal may be applied to the one or more correction factors to take into account the shape of the pulse of the detection laser beam. The laser-ultrasound system may further comprise a three-dimensional vision system that measures the shape of the target, wherein the system uses the information provided by the three-dimensional vision system to apply a correction to the calculated one or more correction factors. The at least one processing unit may comprise a first processing unit that records operational parameters during the collection and processing of the portion of the detection laser beam that is reflected by the target; a second processing unit that calculates the one or more correction factors for each signal using the recorded operational parameters; and a third processing unit that scales the amplitude of each signal using the one or more correction factors.

Other embodiments of the present disclosure may provide a laser-ultrasound system comprising a generation laser beam that generates ultrasonic displacements in a target; a detection laser that is modulated by a phase modulator before illuminating the target; an optical and electrical assembly that collects and processes a portion of a detection laser beam that is reflected by the target to produce signals representative of mechanical displacements; and at least one processing unit that calculates one or more correction factors for each signal using the amplitude of the feature in the signal related to the phase modulator and scales the amplitude of each signal using the one or more correction factors. The laser-ultrasound system may further comprise a three-dimensional vision system that measures the shape of the target, wherein the system uses the information provided by the three-dimensional vision system to apply a correction to the calculated one or more correction factors. The at least one processing unit may comprise a first processing unit that calculates one or more correction factors for each signal using the amplitude of the feature in the signal related to the phase modulator; and a second processing unit that scales the amplitude of each signal using the one or more correction factors.

Additional embodiments of the present disclosure may provide a method for laser-ultrasound inspection using a laser-ultrasound system having a generation laser, a detection laser, an optical and electrical assembly, and at least one processing unit, the method comprising generating ultrasonic waves in a target; illuminating the target; collecting and processing a portion of a detection laser beam that is reflected by the target; recording operational parameters during the collection and processing of the collected portion of the detection laser beam; calculating one or more correction factors for each signal using the recorded operational parameters; and scaling the amplitude of each signal using the one or more correction factors. The generation laser in the laser-ultrasound system may perform the generating step. The detection laser in the laser-ultrasound system may perform the illuminating step. The optical and electrical assembly in the laser-ultrasound system may perform the collecting and processing step. The at least one processing unit may perform the calculating and scaling steps.

Further embodiments of the present disclosure may provide a process for correction on an amplitude of a laser ultrasonic signal comprising normalizing one or more laser ultrasound signals; calculating an array of correction factors for each of the one or more laser ultrasonic signals each corresponding to each acquisition point at the surface of a part; smoothing the array of correction factors using an N×M kernel; dividing the normalized ultrasound signal by the corresponding smoothed correction factor, and applying an additional correction to compensate for the orientation of the surface of the part. Each correction factor may be equal to the product of the detection light level, the electronic gain, the generation laser energy, and a scaling factor. The process may further comprise analyzing the laser ultrasound signal to produce amplitude, time-of-flight and attenuation C-scans.

Other technical features may be readily apparent to one skilled in the art from the following figures, descriptions and claims.

### BRIEF DESCRIPTION OF THE DRAWINGS

For a more complete understanding of this disclosure, reference is now made to the following description, taken in conjunction with the accompanying drawings, in which:

FIG. 1-1 depicts an implementation of an example system for nondestructive testing according to an embodiment of the present disclosure;

FIG. 1-2 depicts an implementation of an example system for nondestructive testing according to an embodiment of the present disclosure;

FIG. 1-3 depicts an implementation of an example process for testing using a laser ultrasound system according to an embodiment of the present disclosure;

FIG. 1-4 depicts an implementation of an example process for testing using a laser ultrasound system according to an embodiment of the present disclosure;

FIG. 1-5 depicts an implementation of an example process for testing using a laser ultrasound system that generates a calibration signal according to an embodiment of the present disclosure;

FIG. 2A depicts an implementation of a laser ultrasound system testing a material in a pulse-echo mode with acceptable data quality at a high angle of incidence on the material;

FIG. 2B illustrates an implementation of an example model laser ultrasound system testing a material in a pulse-echo mode with data collected and processed at different incident angles;

FIG. 3A illustrates an implementation of example predicted laser generated ultrasonic signals as measured at the top surface of a sample and as measured at some depth below the top surface according to an embodiment of the present disclosure;

FIG. 3B illustrates an implementation of example predicted laser generated ultrasonic signals as measured at various depths inside a part relative to the optical penetration depth according to an embodiment of the present disclosure;

FIG. 4A illustrates an implementation of an example interaction between an optical detection system and a material with an optically transparent top layer according to an embodiment of the present disclosure;

FIG. 4B illustrates an implementation of an example interaction between an optical detection system and a material with an optically transparent top layer, comparing exterior surface displacement measurements to interior displacement measurements according to an embodiment of the present disclosure;

FIG. 5 illustrates an implementation of example changes in observed laser ultrasound signals when testing materials that have a top layer that is transparent to the detection laser wavelength according to an embodiment of the present disclosure;

FIG. 6 illustrates implementation of an example interaction between an optical detection system and a material including a metallic mesh under an optically transparent top layer according to an embodiment of the present disclosure:

FIG. 7 illustrates an implementation of an example laser ultrasound system according to an embodiment of the present disclosure;

FIG. 8 illustrates an implementation of an example process for signal amplitude corrections according to an embodiment of the present disclosure;

FIG. 9 illustrates an implementation of example results before and after applying signal amplitude corrections for different surfaces on the same material according to an embodiment of the present disclosure;

FIGS. 10A and 10B illustrate an implementation of an example mechanism for tilting and rotating a material for evaluating angle of incidence sensitivity and corrective methods according to an embodiment of the present disclosure;

FIG. 11 illustrates an implementation of example signals generated by a laser ultrasound system that generated a calibration signal according to an embodiment of the present disclosure; and

FIGS. 12 A-G illustrate implementations of example relationships that may be utilized in laser ultrasound measurement according to an embodiment of the present disclosure.

### DETAILED DESCRIPTION

In various implementations, a laser ultrasound system may be utilized to test material quality. The laser ultrasound system may generate a laser beam for application to a material and measure signals generated by the application of the laser beam to the material. The measured signals may be altered based on correction factors and the quality of the material may be determined based on the altered signals. In some implementations, a calibration signal may be generated by the laser ultrasound system to identify distortion properties of materials, determine correction factors, etc.

The material testing may be performed to determine a material quality during production, after manufacture, and/or after use. The testing may ensure a material being tested satisfies quality standards (e.g., company, industry, and/or government standards). For example, materials used in aircraft, ships, boats, and/or cars may be subject to quality standards (e.g., during manufacture and/or for continued use). Nondestructive testing may allow the quality (e.g., a quantitative measurement of quality) of a material to be determined without substantially damaging the material being tested.

Laser ultrasonic measurement systems may be used for testing materials, such as various components and complex structures. Laser ultrasonic systems may be utilized for many industrial applications, such as nondestructive testing (e.g., substantial damage to a material is resisted and/or the material may still be suitable to be utilized for its intended purpose after testing) of complex composite structures, measurement of steel at high temperature, measurement of wafer properties, measurement of paint thickness, etc. Laser ultrasound may be used to detect a number of manufacturing defects that may be present in composite materials, such as: delaminations, disbonds, foreign materials, excessive porosity, incomplete cures, voids, bubbles, protrusions, recesses, etc. The properties obtained from the testing may be utilized to determine a quantitative quality (e.g., rating) of the material.

For example, the laser ultrasonic measurement systems may generate a laser beam, and a signal (e.g., reflected laser light and/or ultrasonic waves generated by the laser) may be generated based on the application of the laser beam to the material. The laser ultrasonic system may measure the signals and may alter the signals to reduce various effects on the signals (e.g., by applying correction factors), such as signal distortion due to material properties, noise, etc.

For example, laser ultrasonic systems may be subject to effects such as, signal amplitude variation with different material configurations. In some implementations, the signal will include a distortion and/or corruption of the measurement of the front surface displacement (e.g., first echo signal) when interrogating materials that exhibit optical transparency at the detection laser wavelength. Optical transparency of the top surface may produce variations of the observed front surface displacement (e.g., first echo signal), relative to the rest of the ultrasonic signal, as the interrogation angle is changed. This phenomenon may vary from mild to extreme depending on, for example, the complex interaction of the detection laser with the top surface and any subsurface structure that is illuminated. In some implementations, the ratio of the back surface signal (e.g., second signal), compared to the front surface signal, may fluctuate, in some implementations, by as much as a factor of ten in amplitude for relatively small changes in interrogation angle. These observed fluctuations in signal amplitude might compromise the utility of laser ultrasound data and/or the ability to obtain an accurate quality assessment.

Laser ultrasound systems may be capable of determining a quality of a material with complex shapes, such as curves (e.g., as opposed to simple planar structures). However, if at least a portion of the material exhibits optical transparency at the detection laser wavelength, a signal generated when the laser is applied to the material may be distorted. If the distortion is not accounted for and/or identified, the distortion may be applied to a quality of the material and a quality rating may be decreased and/or increased based on the distortion rather than an actual quality of a material. Thus, the measured signals may be altered by a correction factor, such as a distortion correction factor, to generate a corrected signal. The quality of the material may then be based on the corrected signal. By utilizing correction factors, more accurate testing may be provided of materials previously considered unsuitable for conventional laser ultrasound systems (e.g., materials that exhibited strong angle of incidence variations and/or materials which needed modifications to the top surface, such as manual scuffing and/or coating alteration, to obtain accurate quality assessments).

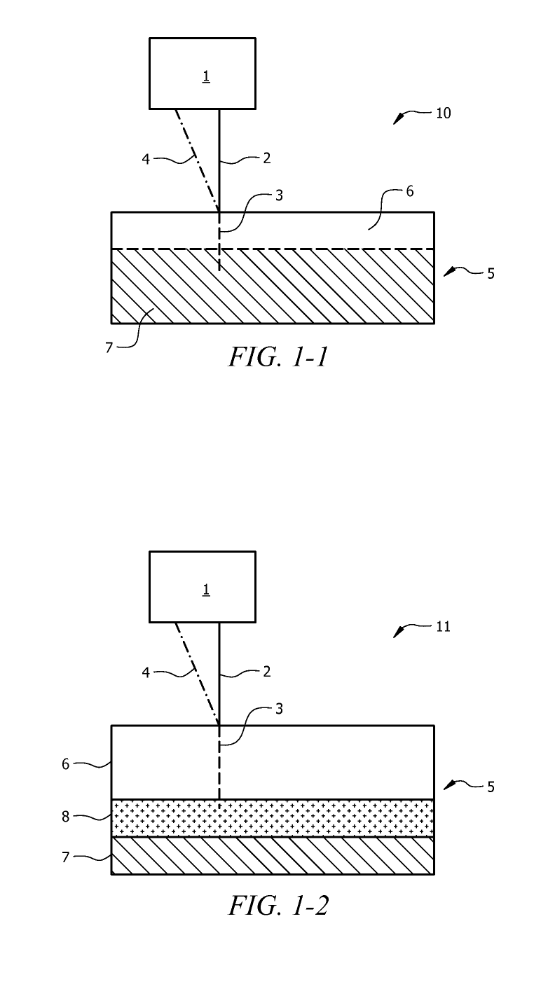

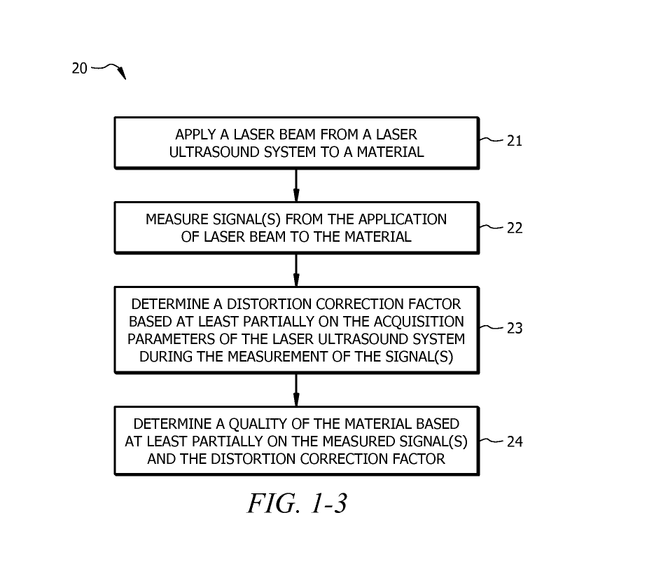

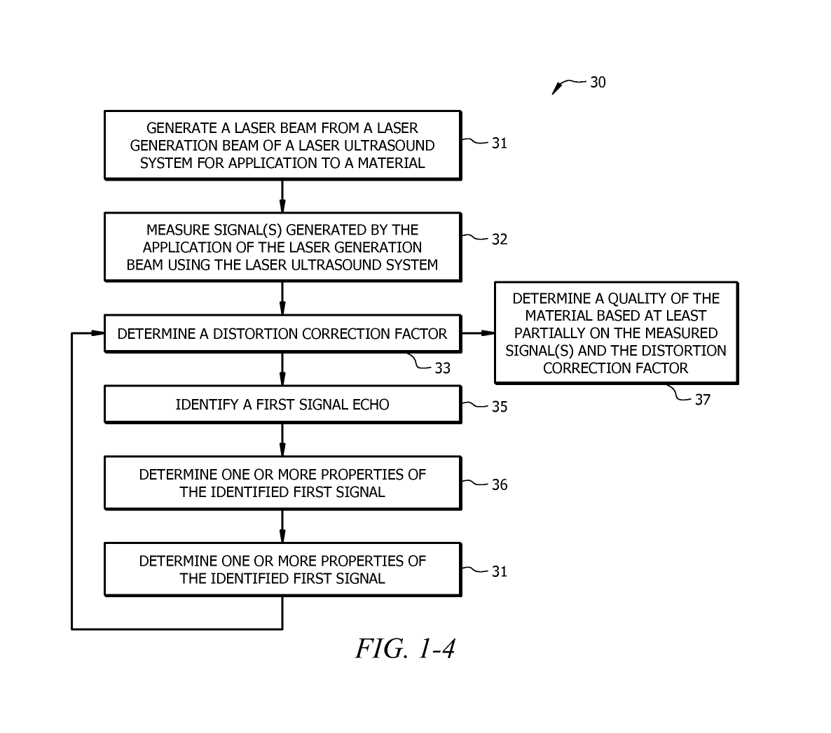

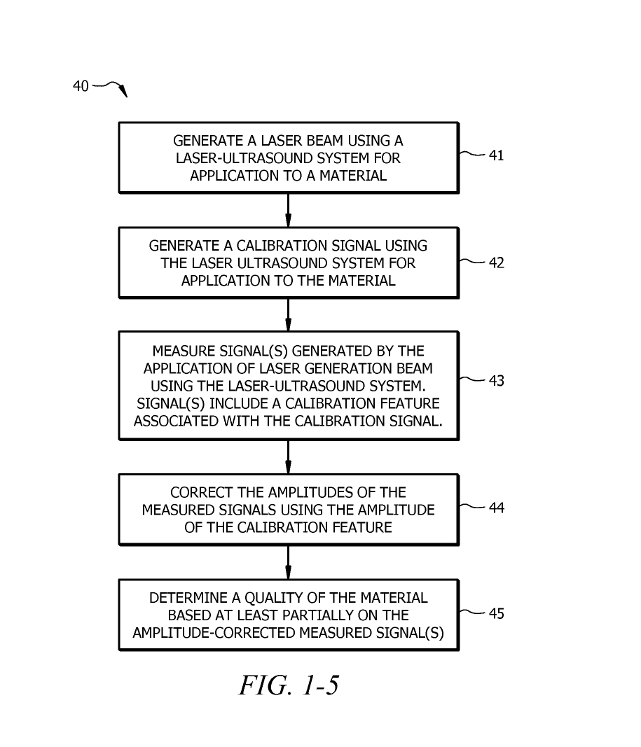

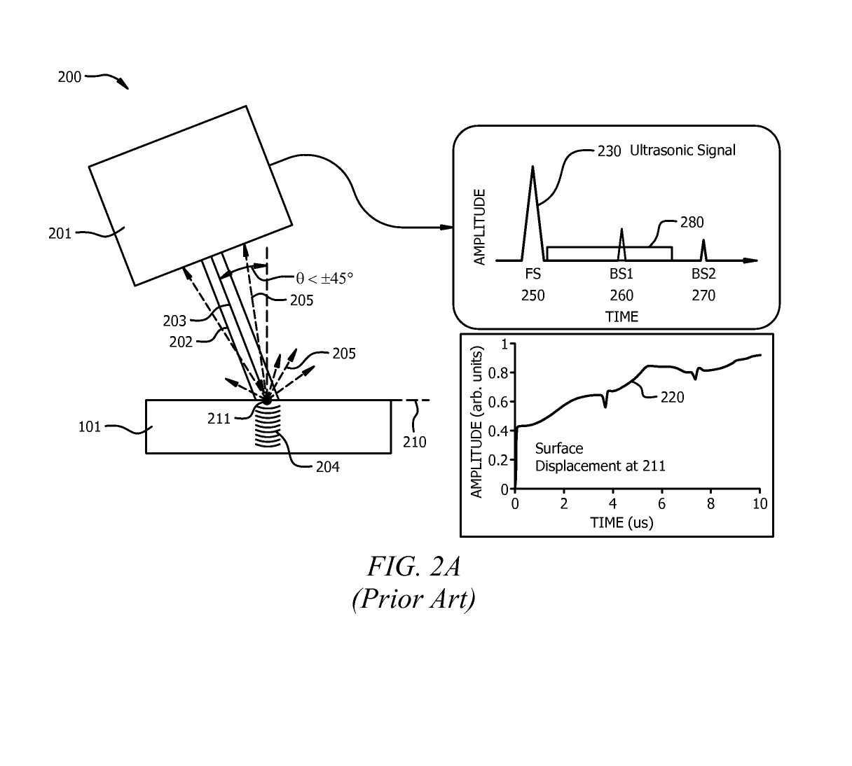

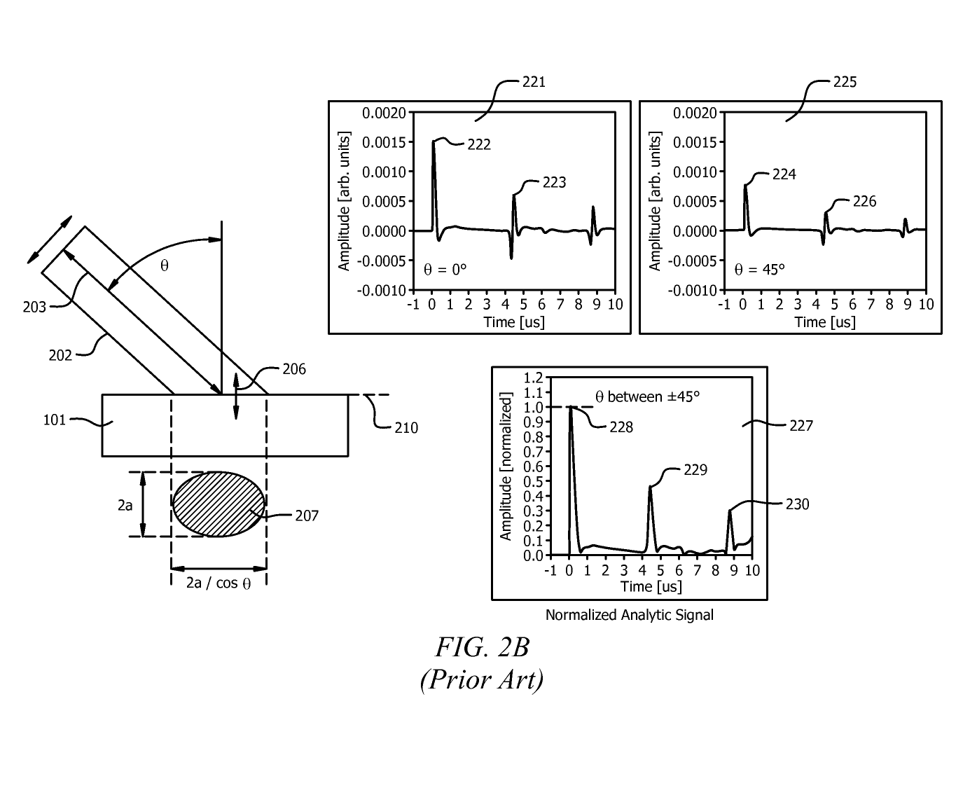

FIGS. 1-1 and 1-2 illustrate implementations of example arrangements 10, 11 for nondestructive testing according to an embodiment of the present disclosure. As illustrated, laser ultrasound system 1 may be disposed proximate material 5 to test the quality (e.g., a qualitative measurement of quality, such as grading of imperfections, percentage of imperfections, pass/fail, etc.).

The laser ultrasonic system may be a non-contact system that uses one laser to generate an ultrasonic wave and a second laser-based detection system to measure the response of the material to the induced ultrasonic wave. In some implementations, a first short pulsed laser beam, referred to as a generation laser beam, may be directed to the surface of a structure to generate ultrasonic waves in the structure. A second laser beam, referred to as the detection laser beam, is used to illuminate the structure. The detection laser light may be collected after reflecting or scattering off the structure and processed with a suitable optical device to produce signals representative of the time history of the ultrasonic wave interactions within the structure. These signals may be analyzed to yield information about the quality of the structure, such as the presence of manufacturing defects and/or a variety of properties of the material.

As illustrated, laser ultrasound system 1 may generate laser beam 2 that may cause ultrasound waves 3 to be generated in material 5. Ultrasound waves 3 may be at least partially reflected back to laser ultrasound system 1 as one or more signals 4. In some implementations, a second laser beam (e.g., laser detection beam) may be generated by laser ultrasound system 1. The second laser beam may be applied (e.g., shined on) to the material and the signals generated by the reflection of the second laser beam may be measured by the sensors as the signals generated by the application of laser beam 2 to the material. The signal(s) may include ultrasonic signals.

The properties of the measurements, such as the angle which the light is reflected (e.g., incidence angle), the amplitude of the signal, the shape of the signal, etc. may be based at least partially on properties of laser beam 2, ultrasound waves 3, and/or the material. The material may include polymer such as epoxy resins, polyurethane resins, and/or thermosetting plastics. As illustrated in FIG. 1-1, material 5 may include optically transparent layer 6 (e.g., a layer in which at least a portion comprises a material that is optically transparent to the detection laser beam and/or a wavelength) above second layer 7. At least a portion of second layer 7 may not be optically transparent. Optically transparent layer 6 may affect the properties of the signal transmitted (e.g., reflected back to) laser ultrasound system 1. For example, if at least a portion of the top surface of optically transparent layer 6 is smooth and/or shiny, at least a portion of the signal (e.g., light from laser beam 2 and/or light from a second laser beam used for the detection) may be reflected without penetrating to deeper portions (e.g., second layer 7) of material 5.

As illustrated in FIG. 1-2, material 5 may include one or more additional layers 8 disposed between second layer 7 and the top surface of material 5. For example, the additional layer may include reinforcement materials (e.g., to increase the strength and/or resistance to cracking) such as mesh (e.g., metallic mesh), carbon fibers, and/or glass fibers. The reinforcement materials may cause the signals to be distorted (e.g., light from the second laser beam and/or laser beam 2 may be refracted and/or interfere with the signals based on other portions of material 5). Material 5 may include a layer proximate a top surface of material 5, a portion of which may or may not be optically transparent.

Although FIGS. 1-1 and 1-2 illustrate implementations of arrangements used to test materials, other arrangements may be utilized without departing from the present disclosure. In some implementations, the laser ultrasound system may include and/or be coupled to a computer (e.g., a desktop, a laptop, a tablet computer, a smart phone, and/or a server). The computer may include a memory to store data such as signal analysis data, algorithms for determination of distortion correction factors, algorithms for smoothing kernels, algorithms for other correction factors, previously obtained data, and/or other data. Module(s) may be stored in the memory of the computer and executed by processor(s) of the computer. The module(s), such as a testing module, may perform one or more of the described operations to facilitate measurement and/or material testing using the laser ultrasound system.

The computer system may transmit a signal to a laser generation device of laser ultrasound system 1 to generate laser beam 2. Laser beam 2 may generated by a pulsed laser and/or other type of modulated laser, in some implementations. Reflected light(s) 4, produced by the material due to reflection and/or refraction of laser beam 4, ultrasound waves 3, and/or a second detection laser beam, may be detected and/or measured by sensor(s) of laser ultrasound system 1. The sensor(s) may include any appropriate sensor, such as interferometers, such as a confocal Fabry-Perot (CFP) interferometer. In some implementations, the sensor may include an optical and/or electro-optical device. The sensor may measure the ultrasound data. For example, to measure ultrasound data, the sensor may demodulate the interaction of the laser beam with the moving surface and/or interior with an interferometer to create laser light intensity (e.g., amplitude) changes and the amplitude changes may be measured with an optical detector.

The detected signals may be measured and analyzed by modules of the computer. Modules of the computer may determine the distortion correction factor for the material being analyzed and may apply the distortion correction factor(s) to the measured signals. Modules of the computer may also determine one or more other correction factors to reduce the effects of noise, laser beam properties, material properties, and/or other appropriate factors. In some implementations, the corrected signals may be presented on a 2-D) or 3-D graph for a user (e.g., via a graphical user interface generated by the laser detection system for presentation to the user).

FIG. 1-3 illustrates example process 20 for testing a material utilizing an arrangement such as arrangement 10 and/or arrangement 11, illustrated in FIGS. 1-1 and 1-2, according to an embodiment of the present disclosure. As illustrated, a laser beam from a laser ultrasound system may be applied to a material (operation 21). For example, the laser ultrasound system may generate a laser beam. The light of the laser beam may be nondestructive to the material (e.g., the laser beam may not substantially damage or produce defects, such as holes and/or recesses in the material). In some implementations, a signal may be received from a user to generate a laser beam for application to a material. The laser beam may cause ultrasonic waves to be generated in the material or a portion thereof. For example, application of the laser beam may cause ultrasonic waves to flow through at least a portion of the material. The ultrasonic waves may be reflected and/or refracted based on the interaction of the waves with portions of the material.

Ultrasonic waves generated by the application of the laser beam to the material may be measured (operation 22) resulting in signal(s). For example, as the laser beam and/or ultrasonic wave are transmitted through at least a portion of the material (e.g., to a predetermined depth of the material), the ultrasonic wave may be reflected and/or refracted based on properties of the material. In some implementations, the sensors may include a second laser beam, such as a detection laser beam, which is generated by the system to be contemporaneously (e.g., with the first laser beam) applied to the material. The second laser beam may be reflected and/or refracted by the material as the signals. A portion of the reflected and/or refracted light beam is converted into signal(s) by sensor(s) of the laser ultrasound system.

A distortion correction factor may be determined based at least partially on the parameters of the laser-ultrasound system during the acquisition of the signal(s) (operation 23). Some materials, such as materials that include optically transparent layer(s) and/or reinforcement(s) (e.g., mesh and/or fibers) and/or other distortion properties (e.g., coatings and/or finish, such as a smooth or polished top surface) may affect the properties of the signal(s) generated by applying a laser beam to the material. For example, a smooth top surface may reflect the laser beam. Reinforcements included in the material may reflect and/or refract the ultrasonic waves and/or laser light. An optically transparent layer (e.g., a layer in which at least a portion includes a material that is optically transparent) may affect the depth at which the ultrasonic waves and/or laser light may penetrate. Properties (e.g., shape, amplitude, and/or time of detection) of signals reflected and/or refracted by a portion of a material may change based on the depth to which the signal traveled. Defects (e.g., bubbles, cracking, voids, etc.) in the material also may affect the properties of the signal. Thus, the change in properties of the generated signal (e.g., from an expected signal, for example based on a control sample of a material) due to material properties may be misinterpreted as defects in the material. However, the laser ultrasound system may identify distortions of the signal based on distortion properties of the material as opposed to defects of the material and reduce the effect of the distortions based on acquisition parameters of the laser-ultrasound system. A distortion correction factor may be determined to reduce the effect of the distortion properties of the material, such as optically transparent layers and/or reinforcements, on the signal (e.g., as opposed to defects in the material).

In some implementations, the distortion correction factor may be determined based on the application of one or more algorithms stored in a memory of the laser ultrasound system. For example, an algorithm (e.g., a normalization algorithm) may be retrieved from a memory coupled to the system to be applied to the first echo signal of a generated signal to normalize the signal (e.g., using first echo signals of other generated signals).

A quality of the material maybe determined based at least partially on the measured signals and the distortion correction factor (operation 24). The quality of the material is a quantitative measure of quality. The quality of the material may be based on an evaluation of the material based on criteria (e.g., from government standards, industry standards, standards based on type of use, and/or company standards). For example, the quality of the material may include a rating (e.g., numerical rating, color-based rating, etc.). The distortion correction factor may be applied to the measured signals and the measured signals may be utilized to identify and/or determine defects. For example, reduction in amplitude of a second echo signal (e.g., compared to a control sample) after application of the distortion correction factor may indicate the presence of a void in the material.

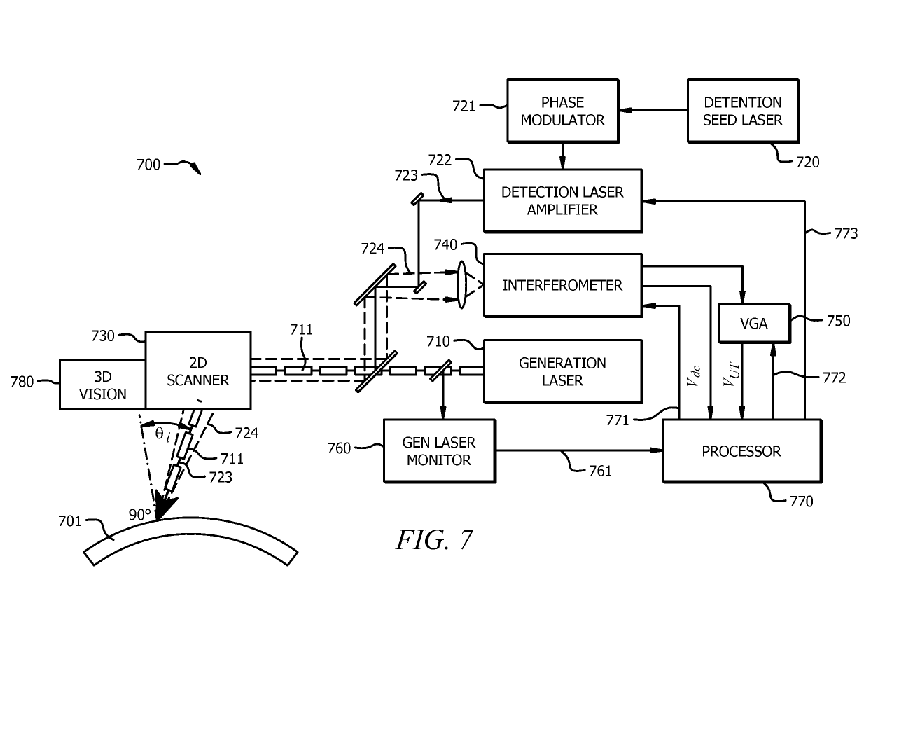

Process 20 may be implemented by various systems, such as systems 10, 11, and 700, illustrated in FIG. 7. In addition, various operations may be added, deleted, and/or modified without departing from the present disclosure. For example, the laser ultrasound system may include a computer system to automatically determine the distortion correction factor. In some implementations, the laser ultrasound system may determine one or more other correction factors. The other correction factors may be applied to the generated signals to reduce noise and/or account for variations in properties of the laser (e.g., light level, electronic gain, laser energy, etc.), for example, in the signal. In some implementations, other correction factors may include a smoothing kernel (e.g., any appropriate smoothing kernel may be utilized to statistically smooth data). The smoothing kernel may reduce noise introduced to the signal data set (e.g., which includes the detected signals) by application of the distortion correction factor. In some implementations, a request for application of the distortion correction factor may be received (e.g., from a user) and the distortion correction factor may be determined for a material. For example, the distortion correction factor may be determined when the material is known to include an optically transparent material. In some implementations, the distortion correction factor may not substantially negatively affect the determined signal data for materials that do not include distortion properties (e.g., optically transparent layer(s) and/or reinforcement(s)), and so the distortion correction factor may be determined for materials that do not include optically transparent layers and/or reinforcements.

FIG. 1-4 illustrates example process 30 for testing a material according to an embodiment of the present disclosure. A laser beam may be generated for application to a material using a laser ultrasound system (operation 31). For example, a first laser beam may be generated by the laser ultrasound system for application on the material or a portion thereof.

Signal(s) generated by the application of the laser generation beam may be measured using the laser ultrasound system (operation 32). For example, the sensor(s) may include a CFP interferometer. A second laser beam may be applied to the same portion of the material as the first generated laser, and the CFP interferometer may measure the reflection of the second laser beam (e.g., signals). In some implementations, one or more sensors may measure the signal(s) and transmit the signal data to a computer of the laser ultrasound system for storage in a memory and/or further processing. The signals(s) may include set(s) of data correlated to a depth to which the signal traveled in the material.

A distortion correction factor may be determined (operation 33). A distortion correction factor may be a number or an array of numbers that may be applied to the signal(s) to reduce an effect of the distortion properties of a material (e.g., optically transparent material layer(s) and/or reinforcement(s)), if any. The distortion correction factor may be determined by a module of the computer system and may be based on the measured signals. In some implementations, the module may retrieve an algorithm, such as the described algorithms described in Example 1, from a memory of the computer system and apply the algorithm to signal(s) and/or portions thereof.

For example, a first signal echo may be identified (operation 34). When a signal is detected using a sensor such as a CFP interferometer, the signal may include several portions such as a first echo signal and a second echo signal. The first signal echo may be a signal associated with front surface displacements and the second signal echo may be a signal associated with a back surface displacement. The first signal echo may be identified as, for example, the first peak in time in the measured signal.

One or more properties of the first signal echo and/or of the signal may be determined (operation 35). For example, properties, such as the amplitude, shape, timing, detection light level, electronic gain, generation laser energy, etc., may be determined by the laser ultrasound system. The properties of the first signal echo may be determined by a module of the laser ultrasound system and stored in a memory of the laser ultrasound system.

A distortion correction factor based at least partially on the determined properties of the identified signal may be determined (operation 36). The distortion correction factor may be a number that when applied to the signal alters the signal such that the first echo signal is similar to a predetermined first echo signal. The predetermined first echo signal may be an expected first echo signal based on experimental data, previous readings, or other first echo signal of other signals measured contemporaneously (e.g., within a reading, such as a 1 second reading). In some implementations, the distortion correction factor may be based at least partially on the detection light level (P_{det}), electronic gain (G_{VGA}), generation laser energy (E_{gen-laser}), and/or a scaling factor (K_{scalefactor}). For example, the distortion correction factor may include a product of the detection light level (P_{det}), electronic gain (G_{VGA}), and generation laser energy (E_{gen-laser}). In some implementations, the distortion correction factor may include a product of the detection light level (P_{det}), electronic gain (G_{VGA}), generation laser energy (E_{gen-laser}), and a scaling factor (K_{scale-factor}).

A quality of the material may be determined based at least partially on the measured signal(s) and the distortion correction factor (operation 37). In some implementations, the distortion correction factor may be applied to the signals and/or portions thereof. For example, a corrected signal may be obtained based on the product of the distortion correction factor and the measured signal. The quality of the material may be determined based at least partially on the corrected signal. For example, variations in the corrected signal (e.g., when compared with other corrected signals, corrected signals obtained from a sample, corrected signals from mathematical modeling, etc.) may be identified and a quality of the material may be determined based on the variations. In some implementations, voids and/or bubbles may cause a corrected signal to have smaller amplitude than an expected corrected signal (e.g., obtained from testing of a different portion of the material and/or a control sample).

In addition, various operations may be added, deleted, and/or modified. For example, an additional correction may be applied to the measured signal. The additional correction may be the application of a smoothing kernel (e.g., any appropriate data smoothing algorithm) to the measured signals after the application of the distortion correction factor to obtain the corrected signals. In some implementations, other noise reduction algorithms (e.g., any appropriate noise reduction algorithm for data sets) may be applied to the measured signals before and/or after application of the distortion correction factor. In some implementations, if the generation laser pulse energy is approximately constant, the distortion correction factor may be based on the product of the detection light level and the electronic gain. Additionally, a constant scaling factor may be applied to the product of the detection light level and the electronic gain to approximately obtain a predetermined number, such as 1. In some implementations, the distortion correction factor may reduce the affect of the top layer of a material (e.g., smooth top surface, optically transparent top layer, etc.) to the signal.

In some implementations, additional correction factors may be applied to the measured signal to obtain a corrected signal, based upon which a quality of the material may be determined. For example, a normalization correction factor may be applied that normalizes the measured signal relative to the amplitude of the first signal echo. In some implementations, an orientation correction factor may be applied based on the orientation of the surface of the material relative to the laser ultrasound system. For example, the orientation correction factor may reduce the effect of the orientation of the material and/or a surface thereof such that the signals may be compared with other signals at different orientations to determine a quality of the material.

In some implementations, the laser ultrasound system may introduce a calibration signal in the measured signal to facilitate the identification of and/or correction to account for the effect of distortion properties of a material, such as a smooth top surface, optically transparent top surface, mesh reinforcements, and/or fiber reinforcements at least partially disposed in the material. FIG. 1-5 illustrates example process 40 for testing a material using a laser ultrasound system that is capable of producing a calibration signal according to an embodiment of the present disclosure.

A laser beam may be generated for application to a material using a laser ultrasound system (operation 41). For example, a user may request testing of a material or a portion thereof. The laser ultrasound system may generate a first laser beam in response to the request. The first laser beam may cause the generation of ultrasound waves that travel at least partially through the material. As the ultrasound waves travel through the material, contact with portions of the material may cause at least a portion of the ultrasound waves to be reflected and/or refracted.

A calibration signal may be generated using the laser ultrasound system for application to the material (operation 42). For example, the laser ultrasound system may include a phase modulator. The phase modulator may transmit a calibration signal, such as a signal with a predetermined frequency, amplitude, and/or shape. The calibration signal creates a feature on the measured signal. For example, the calibration signal may be transmitted during the same testing period as the first laser beam. In some implementations, the calibration signal may be transmitted such that receipt of the signals generated by the calibration signal may be detected before or after other signals.

Signal(s) generated by application of the laser beam including the feature created by the calibration signal may be measured (operation 43). For example, sensors may measure first signals (e.g., generated by application of the laser beam to the material and/or generated by application of the first laser and the second laser to the material). In some implementations, since the calibration signal may be synchronized in such a manner that the calibration feature appear in the measurement before the first signal associated with application of the laser beam. The calibration feature may be presented as the first peak on a presentation of results, rather than the first echo signal of the first signal (e.g., when displaying the signals to a user on a graph of the amplitude of the signal over time). In some implementations, properties of the signals, laser beam, and/or calibration signal may be determined based at least partially on the measured signals. For example, properties of the signals may be measured, such as amplitude, shape, timing, detection light level, electronic gain, generation laser energy, etc.

A distortion correction factor may be determined based at least partially on the calibration feature generated by application of the calibration signal (operation 44). Using the known the characteristics of the calibration signal, the calibration feature on the measured signal can be used to calculate the distortion correction factor. For example, the calibration signal can be created by a phase modulator with known characteristics (i.e., ability to modulate light as a function of voltage) and from a known electrical signal. The calibration feature corresponds therefore to a known modulation and its amplitude varies only based on the product gain-light level. The variation of amplitude of the calibration feature is therefore an indication of the variation of the product of the detection light level and the electronic gain. The amplitude of the calibration feature can therefore be used as a distortion correction factor, similar to the correction factor explained earlier. For example, the signal(s) generated by application of the calibration signal may be compared to a second set of signals (e.g., from application of the calibration signal to a control sample, from computer modeling of calibration signal behavior, etc.). Based on the comparison, a distortion correction factor may be determined, in some implementations. Properties of the calibration feature may be utilized to determine the distortion correction feature. For example, the amplitude of the calibration feature may be an indication of the product of the light level and the electronic gain, and thus the distortion correction factor may be based on the amplitude of the calibration feature. In some implementations, the distortion correction factor may be determined based on the light level (P_{det}), electronic gain (G_{VGA}), and/or a scaling factor (K_{scale-factor}).

A quality of the material may be determined based at least partially on the signal(s) associated with application of the laser beam (operation 45).

The laser ultrasound system may determine whether the material has a distortion property based on material information received from a user (e.g., material has optically transparent material) and/or based on measurements from testing a material.

In some implementations, for example, a control sample may include a known quality. The laser ultrasound system may test the material and determine a quality of the material. The determined quality may be compared to the known quality to determine if the material has a distortion property. If the determined quality is not approximately the same as the known quality, then a distortion correction factor may be determined based on the comparison (e.g., the distortion correction factor may be a value that when multiplied by the measured signals produces the known quality rating or approximately the known quality rating).

In some implementations, the calibration signal generated by the laser ultrasound system may be utilized to determine whether a material includes a distortion property. For example, a calibration signal may be generated and applied to a material. The signal generated by application of the calibration signal may be analyzed to determine if a distortion property exists for the material (e.g., amplitude, shape, distortion, etc. of the signal may be determined).

If a determination is made that the material includes a distortion property, then a distortion correction may be applied. If a material does not include a distortion property, then the quality may be determined based on the signals generated by application of the laser to the material and/or corrected signals (e.g., one or more other noise correction signals, orientation correction signals, and/or smoothing kernels may be applied to the signals).

In some implementations, the distortion correction factor may be determined for materials with distortion properties, materials with unknown properties, and/or materials without distortion properties. The quality of the material may be determined based at least partially on the determined distortion correction factor and the signals generated by application of a laser beam to the material.

In various implementations, laser ultrasonic signals may be compensated for system and material variances to improve data quality for automated defect analysis. Signals may be processed in a manner that combines corrections for uncertainties associated with the measurement process with a localized adaptation to material characteristics to improve data uniformity. In some implementations, signal amplitude corrections may be utilized as a distortion correction factor for measurements of materials that exhibit optical transparency at the detection laser wavelength.

In one embodiment, laser ultrasonic signals may be generated and detected using an automated system to allocate system resources to maximize and/or substantially improve signal quality and remain within the dynamic range of the available resources. System measurement fluctuations may be minimized and/or reduced using information present in the individual ultrasonic signal. In some implementations, using localized system measurement information in an adaptive manner may separately minimize global variations in the physical characteristics of the material-measurement interaction. During inspection of a region of a structure, the nominal energy and/or energy density of the generation laser may be established, although shot-to-shot adjustments may be utilized (e.g., in conjunction with and/or instead of). In some implementations, intensity of the detection laser may be adjusted in an automated manner to produce a predetermined signal-to-noise ratio (e.g., optimal and/or to satisfy a quality criteria). In some implementations, electronic gain of the analog signal voltage may be varied to match the dynamic range of the conversion process to a digital representation of the ultrasound for subsequent computer processing. Individual fluctuations of the measurement process may be minimized and/or reduced by compensating values in the signal by a measured feature that varies linearly with the unknown fluctuations. Such a feature, for example, may be derived from the front surface displacement signal. At least a portion of the points within the signal may be normalized by a value proportional to this derived value to produce a signal substantially insensitive to system fluctuations.

The value of the locally derived normalization feature, relative to the whole ultrasonic signal, may become distorted or corrupted when certain materials are interrogated at changing angles of incidence. The physics of this angle of incidence measurement error may be minimized using a correction factor. In some implementations, a smoothing kernel, such as a derived value representative of a small kernel of locally averaged system parameters proportional to the detection light level, electronic gain, and generation laser energy, may be utilized. The combination of normalization of individual signals and compensation by locally derived system parameters may alter signals to produce a set of corrected signals that are either substantially independent of the measurement angle of incidence and/or exhibit a response that is easily corrected based on derived or empirical values. The various processes may automatically adjust to a variety of different materials largely independent of the magnitude of the data distortion or corruption.

In some implementations, a calibration signal, such as a predetermined phase modulation, may be placed on the detection laser during a brief period of the recorded signal. This calibration signal may be captured and analyzed approximately simultaneous (e.g., during the same measurement period) with the unknown ultrasonic signal and may be used to compensate for system measurement fluctuations, in some implementations. The process may generate results that may be substantially independent of the measurement angle of incidence and/or may allow a real-time data integrity verification of the optical measurement system.

In various implementations, laser generated and laser detected ultrasonic signals may be altered to account for measurement amplitude uncertainties when testing materials with top layers that exhibit any amount of optical transparency to the detection laser wavelength. In some implementations, algorithms may be applied that allow individual signal normalization techniques while applying local corrections for optical transparency at the detection laser wavelength.

In various implementations, a method for compensating for the amplitude variations in laser-ultrasonic signals obtained with a laser-ultrasonic system from a part having a top layer at least partially transparent to the wavelength of the detection laser may include: obtaining at least one laser-ultrasonic signal from a point on a part; acquiring information from the laser-ultrasonic system; and/or applying an amplitude correction to the laser-ultrasonic signal to compensate for the possible effects of a top layer at the surface of the sample using the information acquired from the laser-ultrasonic system.

Implementations may include one or more of the following features. A first amplitude correction may be applied before the described amplitude correction. The first amplitude correction may include normalizing the laser-ultrasonic signal relative to an amplitude characteristic of the first signal echo. The information acquired from the laser ultrasonic system may include the electronic gain used to acquire the laser-ultrasonic signal and the detection light level on the detectors at the acquisition. The information acquired from the laser-ultrasonic system may include the energy of the generation laser pulse that generated the ultrasonic displacement of the acquired laser-ultrasonic signal. The amplitude correction, a type of distortion correction factor, may be based at least partially on dividing the laser-ultrasonic signal, after the first amplitude correction, by a factor equal to the product of the electronic gain with the detection light level during the acquisition with the energy of the generation laser pulse and with a scaling factor. In some cases, the detection light is pulsed. When pulsed, the detection laser light level might change during the duration of the acquired signal. That change of the light level (or the pulse shape) during the signal acquisition must also be taken into account. In that case, the change of the light level as a function of time translates as a change in the value of the correction factor as a function of time of the signal. The factor (e.g., distortion correction factor) may be smoothed by an N×M kernel where N or M or both are larger than 1 before correcting the amplitude of the at least one laser ultrasonic signal. In some implementations, a third amplitude correction, such as an orientation correction factor, may be applied to the laser-ultrasonic signal to reduce the effect of the orientation of the surface of the part at the point where the generation laser impinged the part. The third amplitude correction may be calculated using information provided by a 3D vision system. The second amplitude correction may be adjusted based on the shape of a feature of the laser-ultrasonic signal. The feature of the laser-ultrasonic signal (e.g., that is adjusted by the distortion correction factor) may be the polarity of a feature of the laser-ultrasonic signal.

In various implementations, a laser-ultrasonic system that incorporates an amplitude correction for the laser-ultrasonic signals acquired from a part that has a top layer at least partially transparent to the wavelength of the detection laser may include: a pulsed generation laser to generate ultrasonic displacement in a part; a detection laser to illuminate the part; an interferometer to demodulate detection laser light reflected off the part; a processor to acquire the laser-ultrasonic signals and control the system components; and/or algorithm(s) used by a processor to apply a correction on the amplitude of the laser-ultrasonic signal to compensate for the effects of a top laser at the surface of the part where the top layer is at least partially transparent to the wavelength of the detection laser.

Implementations may include one or more of the following features. The algorithm may include: calculating a correction factor based on system parameters during the acquisition; dividing the laser-ultrasonic signal by the correction factor; changing a generation/detection spot size; altering the system such that the detection laser may be larger than the generation laser; and a 2D scanner may be utilized with a one or two or more mirror design.

In various implementations, calibration of new materials may include: mounting small 2″×2″ sample on a rotation stage for Phi; mounting rotation stage on a goniometer for Theta; collecting data as a function of {Theta, Phi}. In some implementations, unidirectional tapes and some mesh may have stronger Phi variation. In some implementations, a tool side may have stronger Theta variation compared to a bag side. Calibration may be utilized for empirical correction, in some implementations. The corrections may be validated on actual test parts (e.g., material to be tested). In some implementations, a limited area is inspected/analyzed by the described systems from different angles as a check.

In various implementations, a method to compensate for the amplitude variations in laser-ultrasonic signals obtained with a laser-ultrasonic system from a part having a top layer at least partially transparent to the wavelength of the detection laser may include: measuring at least one laser-ultrasonic signal from a point on a part; simultaneously adding a calibration feature to the measured signal; using the calibration feature on the laser-ultrasonic signal to determine characteristics of the laser-ultrasonic system during acquisition of the laser-ultrasonic signal; and/or applying an amplitude correction to the laser-ultrasonic signal to compensate for the possible effects of a top layer at the surface of the sample using information obtained from the calibration feature.

In some implementations, a component may be included in the laser ultrasound system to add a calibration feature to laser-ultrasonic signals acquired from a part that has a top layer at least partially transparent to the wavelength of the detection laser. The laser-ultrasonic system may include, for example: a pulsed generation laser to generate ultrasonic displacement in a part; a detection laser to illuminate the part; an interferometer to demodulate detection laser light reflected off the part; a device that modifies the detection light in a manner to add a calibration feature to the acquired laser ultrasonic signal; a processor to acquire the laser-ultrasonic signals and control the system components; and/or algorithm(s) used by a processor that apply a correction on the amplitude of the laser-ultrasonic signal to compensate for the effects of a top laser at the surface of the part where the top layer is at least partially transparent to the wavelength of the detection laser using information extracted from the calibration feature of the laser-ultrasonic signal.

In some implementations, processes and/or operations thereof may be performed in combination with other processes such as process 20, process 30, process 40, process 800, other described processes and/or operations thereof. In addition, the processes may be performed by any appropriate system, such as the described systems.

Example implementations of laser ultrasound systems are further described below, by way of non limiting examples:

### Example 1

Example 1 illustrates various implementations of laser ultrasound systems.

Laser ultrasound system 200 is illustrated in FIG. 2A. In FIG. 2A, assembly 201 directs laser pulse 202 to surface 210 of part 101 to induce ultrasonic wave 204. Assembly 201 may not necessarily indicate a single enclosure or assembly, but could be a number of components and sub-assemblies and is schematically depicted in 201 to represent the entire assembly. Ultrasonic wave 204 may propagate along the normal of the top surface of part 101 independent of the angle of incidence of laser beam 202. This laser-based approach may allow testing complex contoured parts (e.g., without precisely controlling the relationship between the surface of part 101 and testing assembly 201). In some implementations, the described systems may allow faster scanning rates, simplified scanning procedures, and/or the ability to collect ultrasonic data on parts with extreme contour changes. Optical detection laser beam 203 may be rendered substantially coaxially with generation laser beam 202. Portion 205 of detection laser beam 203 may be reflected or scattered. Detection laser beam 203 may be smaller, larger or the same in diameter compared to generation laser beam 202; however, it may not be smaller. In some implementations, generation beam 202 and detection beam 203 may be adjusted in size to alter the inspection results. A portion of laser light 205 that interacts with the material surface is collected and processed by assembly 201 to render an ultrasonic wave as shown in a display unit. This optically processed signal 230 is derived from the true surface displacement at point 211, for example, as indicated in graph 220. This processed signal 230 may have typical pulse-echo features such as front surface (FS) 250, first back surface (BS1) signal 260 and second back surface (BS2) echo 270. Ultrasonic signal 230 may be processed in the same manner as previously described using a process gate 280 to indicate the amplitude of first back surface (BS1) signal 260 and the position in time indicative of the part thickness. Although not explicitly shown, assembly 201 includes an optical interferometer capable of demodulating the phase information imparted on collected laser energy 205 after incident laser beam 203 interacts with the movement of part 101 caused by the ultrasonic wave. Example interferometers suitable for this purpose include the confocal Fabry-Perot and photorefractive devices based on two-wave mixing.

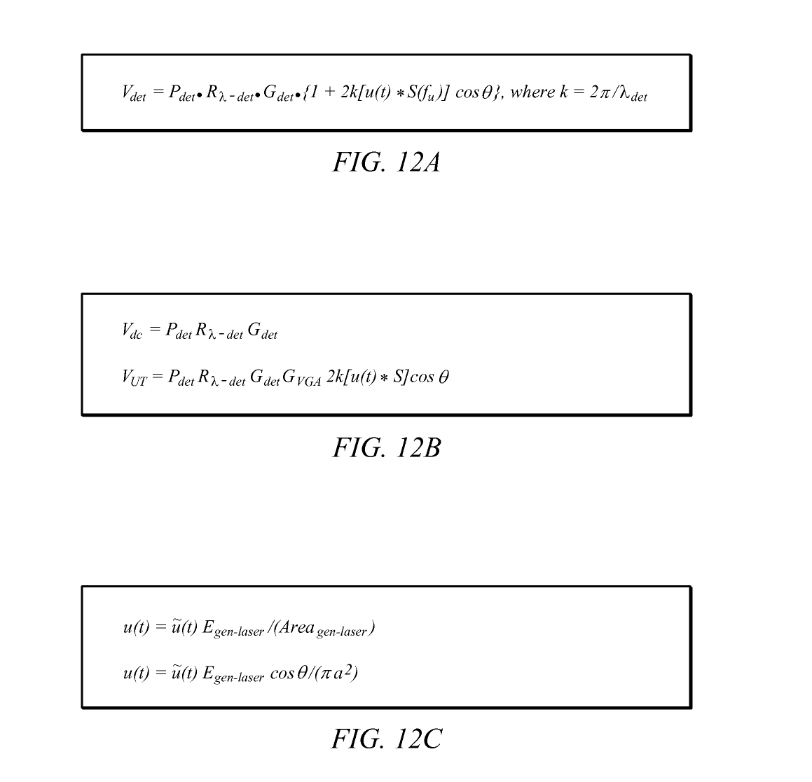

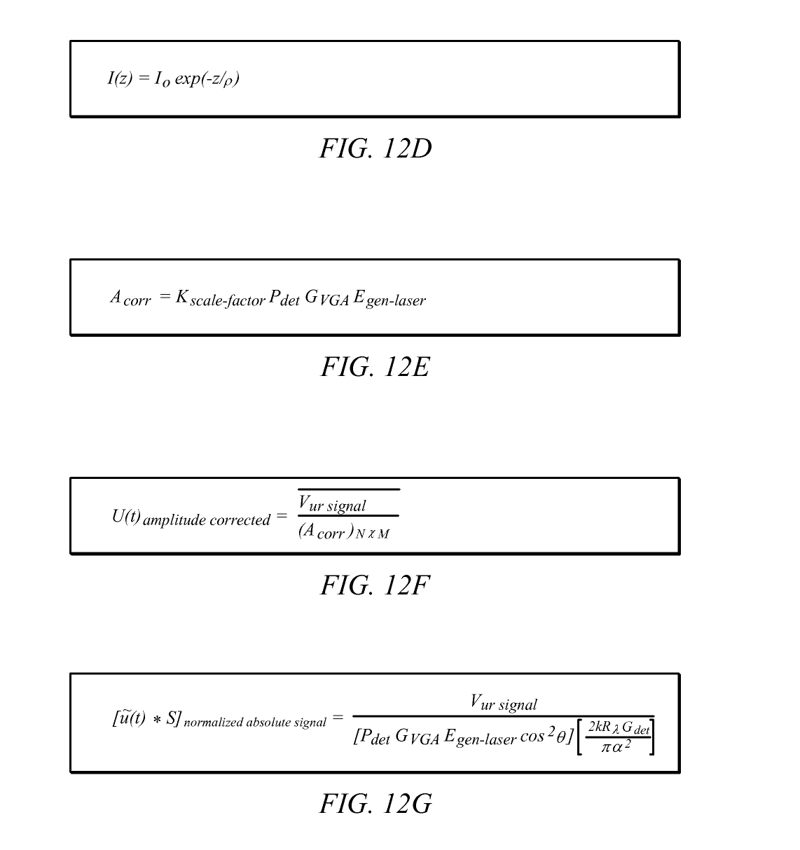

An optical detector associated with an interferometric measurement system will generate a voltage signal, V_{det}, as illustrated in FIG. 12A, where: P_{det} is the optical power on the detector (in watts for example), R_{λ-det} is the photodetector responsivity generating a photo-current, G_{det} is the current-to-voltage gain produced by a resistor or transimpedance amplifier, k is the wavevector related to the detection laser wavelength λ_{det}, u(t) is the true surface displacement, S(fᵤ) is the response function of the interferometer to the frequency of the ultrasonic displacement denoted by fᵤ, and θ is the observed measurement angle relative to the surface normal. The time dependent displacement function (t) may be mathematically convoluted with the frequency dependent interferometer response function S(fᵤ).

In some implementations, the V_{det} signal may be separated into a low frequency, or dc coupled, component. V_{dc}, that is representative of the amount of detection laser light processed and a high-frequency signal, V_{UT}, representative of the ultrasonic information. These two signals V_{dc} and V_{UT} are illustrated in FIG. 12B and may be processed independently as indicated by the new gain term G_{VGA} applied only to the V_{UT} signal. In this example, G_{VGA} represents a high-bandwidth variable gain amplifier (VGA) that may change the amplitude of the signal between ultrasonic signal acquisitions and during a single ultrasonic measurement. V_{dc} and V_{UT} may be digitally captured for computer processing and various digital signal processing methods may be applied to modify the digital representations of these signals.

FIG. 2B shows an example ultrasonic signal in graph 221 derived from a confocal Fabry-Perot (CFP) interferometer observing surface 210 at normal incidence when experiencing displacement 206 corresponding to displacement depicted in graph 220 of FIG. 2A. Graph 225 is the observed signal when angle of incidence is 45° when plotted on the same vertical scale as graph 221. In this example, the CFP measures the cos(45°) projection of the true displacement and the absolute surface displacement value is additionally reduced by another cos(45°) due to the energy density of beam 202 on surface 210 appearing as elliptical projection 207 of the normal incidence energy density. Illustrated in FIG. 12C is the surface displacement u(t) in terms of a normalized displacement û(t) along with the generation laser energy density at surface 210.

Assuming that all other parameters are held constant, a cos₂θ signal reduction may be anticipated as a function of incident angle. The ratio for back surface displacement 223 to front surface displacement 222 may be expected to be similar for back surface signal 226 to front surface displacement 224. The front surface displacements 222 and 224 may be called first signal echo. This modeled (e.g., computer modeled) measurement situation may be beneficially exploited by processing signals 221 and 224 by normalizing to the peak signal. An analytic transformation to the signals presented in 221 and 224 may be performed, rendering unipolar signals that are representative of the signal energy as a function of time. After normalization to the peak value, the analytic transformation of signals 221 and 224 will produce the signal depicted in 227. The analytic signal normalization technique utilized may be any digital signal processing technique commonly used for laser ultrasonic signal processing. This processing technique may compensate for a variety of measurement variables, such as: generation laser energy fluctuations, changes in the generation laser spatial profile at the surface, detection laser power fluctuations, laser beam misalignments, and/or varying angles of incidence. In some implementations, converting measured laser ultrasound data into absolute units may be impractical when applied to complex industrial applications where even small measurement or material interaction uncertainties may be problematic to either accurately measure or control in real-time.

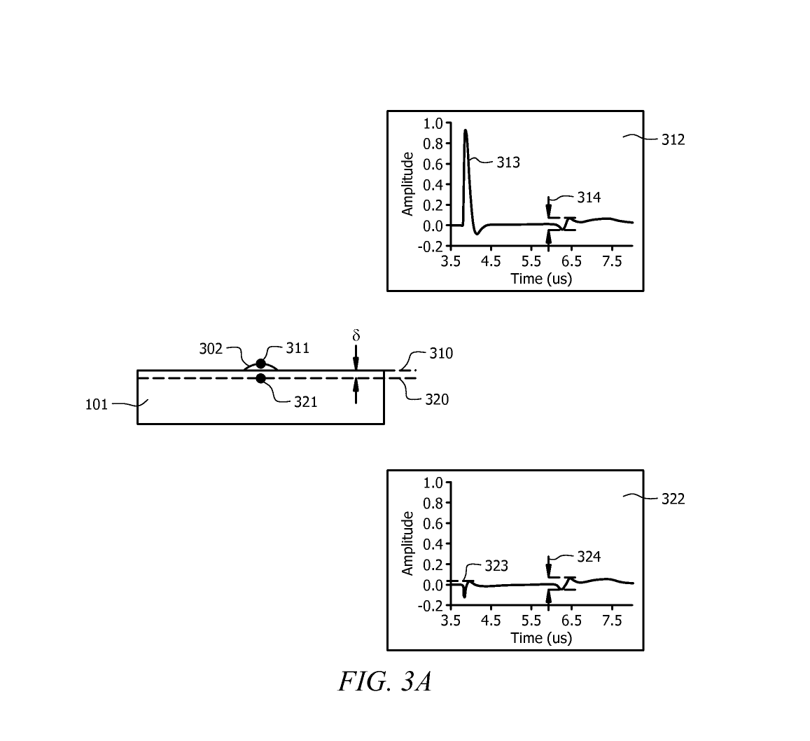

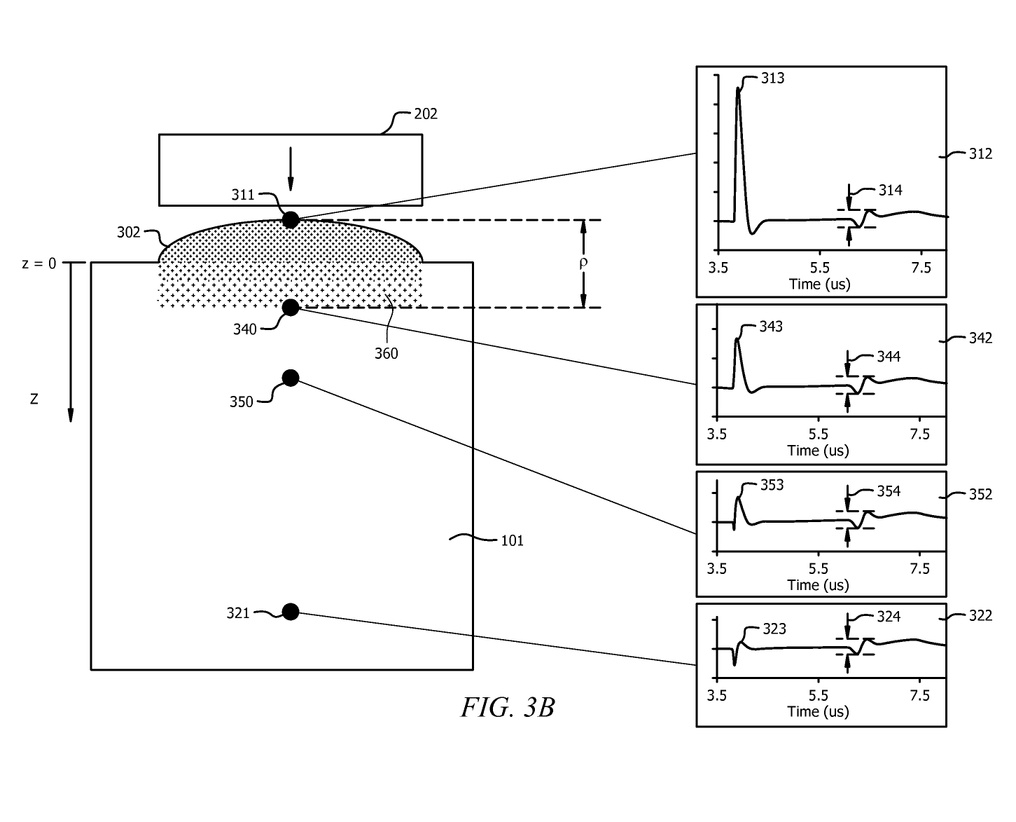

The interaction between detection laser beam 205 and part 101 may produce undesirable and previously unexplained front surface signal amplitude corruption and even profile distortions and thus a correction factor may be applied by the laser ultrasound system. An explanation of this complex optical measurement phenomenon may be introduced by reviewing FIG. 3A where an ultrasonic wave is generated by a pulsed laser in part 101 and as indicated schematically by small surface deformation 302 on the nominal position of top surface of part 101 as denoted by dashed line 310. The optically detected ultrasonic signal at point 311 is presented in graph 312 with first signal echo 313 and back surface peak-to-peak amplitude 314. Next, consider an interior point 321 directly below point 311 and some determined depth below the nominal position of the top surface of part 101 as indicated by second dashed line 320. If this interior point 321 is observed, with for example an optical interferometer, the ultrasonic signal will appear as shown in graph 322 displayed with the same absolute scale as 312. The back surface signal 324 may be similar to value 314 previously described but the first signal echo 323 is significantly lower in amplitude and visibly different in profile compared to first signal echo 313. First signal echo 323 compared to first signal echo 313 is both corrupted and visibly distorted. Theoretical simulations of laser generated and detected ultrasonic situation have shown that at a depth of 100 μm absolute displacement 324 would differ from the surface measured value 314 by ˜15%. Assuming that the measurement location originated from the exposed top surface of part 101 may be erroneous and introduce error in the quality determined for a property. FIG. 3B illustrates the extreme changes in front surface signal profiles if the measurement occurs at the interior of the material instead of the expected exterior top surface. Back surface signal 324 would be improperly corrupted in amplitude if it were processed using the technique of normalization to the peak value of first signal echo 323. In this situation the processed value of back surface signal 324 would be erroneously presented as significantly larger than the expected value shown as back surface signal 314. FIG. 3A illustrates the case where measurement point 321 is significantly deeper than the optical penetration depth of the surface material of part 101 at the wavelength of the generation laser. In the case where point 321 would be at a depth approximately equal or smaller than the optical penetration of the material of part 101 at the wavelength of the generation laser, signals 312 and 322 would not be as dramatically different. These cases are illustrated in FIG. 3B.

FIG. 3B shows signals calculated using a mathematical model of generation of ultrasonic waves by laser at various depth of part 101. In FIG. 31, generation laser beam 202 penetrates into the top surface of part 101 and is absorbed over a depth characterized by the optical penetration depth ρ. Optical penetration depth ρ is a characteristic of the material of part 101 and indicates the decrease of energy density of the generation laser beam 202 as a function of depth z inside part 101. I₀ is the density of energy of generation laser beam 202 at the surface of part 101 and intensity I(z) as a function of depth z inside part 101 is illustrated in FIG. 12D.

As the measurement points inside part 101 becomes deeper and deeper relative to optical penetration depth ρ, the measured laser-ultrasonic signal transforms in shape relative to expected surface signal 312 measured at point 311. For example, at point 340 corresponding to a depth z approximately equal to optical penetration ρ, measured laser ultrasonic signal is indicated by graph 342. In graph 342, the general shape of the signal is similar to expected surface signal 312 except for the ratio of amplitude 344 over the amplitude of first signal echo 343 that is significantly larger than the ratio of amplitude 314 over the amplitude of first signal echo 313. If both signals 312 and 342 are normalized and gain is adjusted using the amplitude of first signal echoes 313 and 342, amplitude 344 will appear significantly larger than amplitude 312 while absolute values are approximately the same. This change in apparent amplitude would lead to erroneous characterization of the material and no difference in the shape of signal 342 relative to surface signal 312 would indicate that a problem exists in the normalization of the signal amplitude.

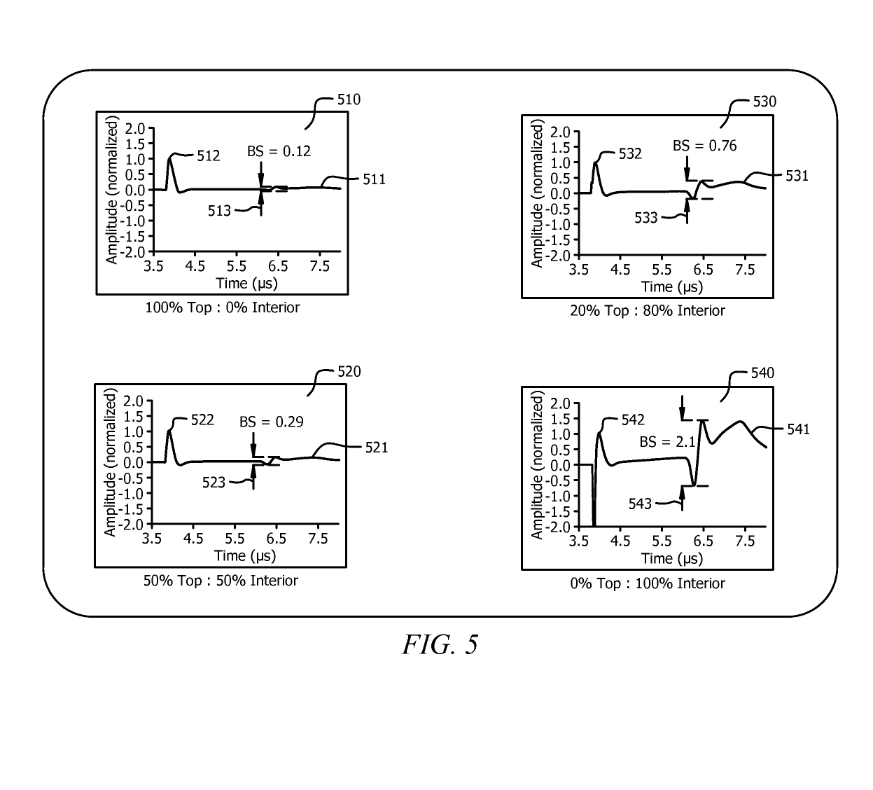

As the measurement point becomes deeper and deeper in part 101, as for points 350 and 321, the shape of first signal echoes 353 and 323 of signals 352 and 322 become significantly different from the shape of first signal echo 313, indicating a problem with the origin of the measurement inside part 101. Once again, normalization and automatic gain compensation of signals 352 and 323, if done relative to first signal echoes 353 and 323, will give erroneous values to back wall echo amplitudes 354 and 324. If the measured signal comes from a mix of collected light originating from both the top surface and a point as deep inside part 101 like as points 350 or 321, as illustrated in FIG. 5, the amplitude of the first signal echo used to normalize the signal will still be corrupted but the shape of the measured signal will not give any indication about the presence of an amplitude normalization problem.

Thus, the change of shapes of signals 312, 342, 352, and 322 may be physically explained. In the case of signal 313, the first signal echo 313 is representative of the mechanical displacement caused by the thermal expansion of the whole volume 360 of material heated by the absorption of the generation laser pulse. Thermal expansion occurs in all directions but only in the direction of z<0 that the material is not constrained and may expand freely resulting in a large positive component in first signal echo 313 of signal 312. When the measurement is made inside the part, like at point 340, only the fraction of the generation laser pulse that was absorbed at a depth larger than the depth of point 340 contributes to the mechanical displacement of point 340. This smaller mechanical displacement results in a smaller positive component in first signal echo 343 of signal 342. As the depth is increased, like at point 350, the fraction of the generation laser pulse that is absorbed at a depth deeper than point 350 becomes very small, providing a very small positive component of first signal echo 353 of signal 352. A negative component becomes to appear in first signal echo 353 of signal 352. This negative component is caused by the ultrasonic wave generated within thermal expansion volume 360 and that travels towards the back wall of part 101. Finally, for point 321 that is at a depth significantly larger than the optical penetration depth, there is not significant positive component of first signal echo 323. The negative component of first signal echo 323 is due to the ultrasonic wave generated in thermal expansion volume 360 and traveling towards the back wall, similarly to the negative component of 353. The ultrasonic wave generated in thermal expansion volume 360 has two components. One component corresponds to a positive signal associated with mechanical displacements towards the z<0 (as for first signal echoes 313 and 343) and another component corresponds to a negative signal associated with mechanical displacements towards z>0. The positive component travels towards z<0 and is reflected by the free surface. The polarity of the displacement is preserved by ultrasonic reflection at a fee surface. The negative component travels directly out of the thermal expansion volume towards z>0 and point 321. The negative component arrives therefore first at point 321, as shown by the first negative signal of first signal echo 323. The positive component arrives after.

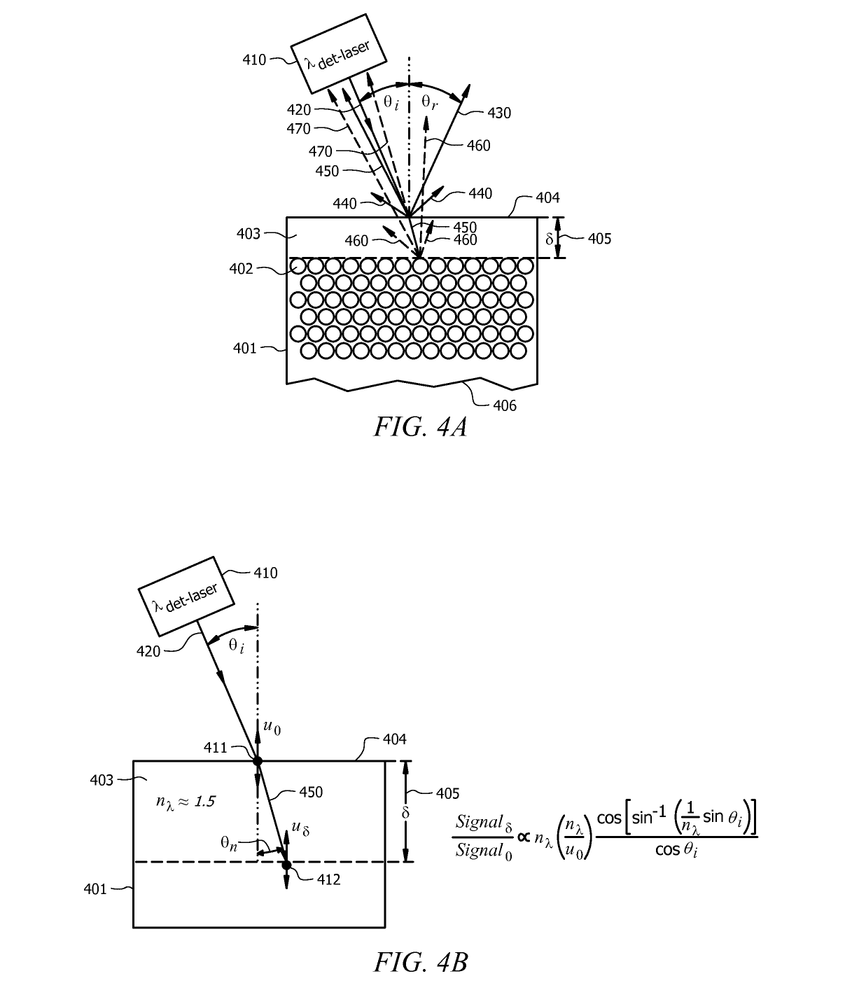

These previously unexplained measurement corruptions for some material types as a function of inspection angle may now be understood in detail by reviewing FIG. 4A. In this example, a cross sectional view of part 401 shows internal structure 402, such as layers of carbon fibers, embedded in matrix 403, such as an organic polymer material. Of particular note is that structure 402 is below top surface 404 at some depth 405. Next consider a laser ultrasound measurement system 410 that comprises a source laser emitting beam 420 with wavelength λ_{det-laser}, directed toward surface 404 at some angle θi. The incident laser source will have some component reflecting off at an angle θr=θi in addition to some scattered light 440 going in many directions with varying intensities relative to θi. Reflected ray 430 will only return to measurement system 410 when the incident angle to the surface normal is sufficiently small and when the surface roughness of surface 404 is negligible. Reflected beams 430 will typically be very intense relative to the scattered light due to the nearly collimated properties of return beam subject to either to strong reflecting surface conditions or less intense but well-known Fresnel reflections that may occur. Some portion of incident laser light 420 will scatter from any rough surface texture present on surface 404 into beams 440. A fraction of scattered beam 440 will return to measurement system 410 as denoted by 450. At least a portion of the measurements using light 430 will be representative of displacements occurring at top surface 404. Incident laser beam 420 may also penetrate into part 401 through top layer 405 along path 450 if matrix 403 is partially transparent at wavelength of beam 420. The standard optical laws of reflection, refraction and absorption would apply to the interaction of beam 420 as it impinges on surface 404 and travels through top layer 405 along path 450. Beam 420 will reflect and scatter along many potential directions as denoted by scattered light 460 after interacting with internal structure 402. Some fraction of the internally reflected or scattered light 460 will return to measurement system 410 as identified by paths 470. Thus, the measurement system 410 may simultaneously receive laser light from the top surface via paths 430 and 450 (exterior reflection and scattering) and from the interior of the material at some depth 405 along paths 470 (internal reflection and scattering). The signal produced when observing a moving surface with an optical interferometer will be proportional to the cos θ projection of the perpendicular displacement and inversely related to the optical wavelength. FIG. 4B further illustrates refraction effects for interior point 412 compared to exterior point 411. FIG. 4B illustrates the effects caused by variations in the incident angle and measurements inside a material with an optical index of refraction greater than 1. This may be a very complex interaction that may not be measurably present if the top surface is either not transparent at the detection laser wavelength or is sufficiently rough that very little light may pass through top interface 404 twice. In some implementations, some materials may be highly optically transparent, and the surface texture may be sufficiently smooth that at near normal angles of incidence a preponderance of light will be reflected from the top surface while only a few degrees off of normal incidence only scattered light 460 from interior will return to measurement system 410. Industrial manufacturing processes for composite materials used on aircraft, for example, often have one surface that is referred to as the “tool” side and is typically very smooth and often optically transparent and the opposing surface is called the “bag” side and is typically less transparent and frequently optically rough as indicated by surface 406 of FIG. 4A. The same material may have dramatically different laser ultrasound behavior both in absolute signal amplitude and inspection angle of incidence depending on which surface is inspected. Typically the bag-side has been the preferred surface for laser ultrasound inspections. Although not explicitly shown, some materials may behave differently depending on orientation. For example, a material where the interior measurement phenomena might be very weak along one axis but very strong along a perpendicular direction. Materials with optical transparency and smooth top surfaces, might exhibit this behavior more than other materials. The quantity of light reflected from the interior relative to the light reflected by the top surface might also depend on the orientation of the reinforcing fiber. Light may be preferentially reflected back to the laser-ultrasonic system if it is nearly orientated along the radial direction of the fibers. Less light would be reflected from the interior if the light is orientated along the longitudinal direction of the fibers. Therefore, if the reinforcing fibers have a preferential orientation near the surface, it is possible that the amplitude corruption effects on the ultrasonic signal will depend not only of the angle of incidence of the detection light but also of the relative orientation of the fibers. This effect may be seen on some part where the amplitude corruption of the ultrasonic signal may be observed along one direction of a given part but not along another direction.

FIG. 5 shows four example signals in graphs 510, 520, 530, and 540 with varying percentages of light reaching the measurement system (410 of FIG. 4) from the top surface (100%, 50%, 20%, and 0%) and the interior (0%, 50%, 80%, and 100%) as identified in each graph. Signal from interior is assumed in FIG. 5 to be coming from a depth significantly larger than the optical penetration depth of the top layer material at the wavelength of the generation laser. Each signal 511, 521, 531, and 541 is normalized to peak first signal echoes 512, 522, 532, and 542 respectively. The measured value of back surface signals 523, 533, and 543 are not in agreement with expected value 513. This data corruption phenomenon may be due to the fact that even highly corrupted signal 531 with 20% exterior light and 80% interior light has substantially the same first signal echo shape as expected signal 511 when 100% of the measurement light comes from the exterior. In some implementations, where all, or nearly all, of the measurement light comes from the interior and that the depth of the feature reflecting the measurement light is significantly larger than the optical penetration depth that first signal echo 542 is visibly different than expected first signal echo 512. In some implementations, where 100% of the measurement light comes from the interior, the first signal echo used to normalize and adjust the gain may become inverted relative to the expected polarity if the depth of the feature reflecting the measurement light is significantly larger than the optical penetration depth. In some implementations, where the feature reflecting the measurement light from the interior is at a depth approximately equal or lower than the optical penetration, even if 100% of the measurement light comes from the interior, no feature of the measured signal may indicate the presence of a problem with the normalization of the signal amplitude, as shown in FIG. 3B.

As illustrated, when the shape of the first signal echo is significantly different from the shape of the expected first signal echo, inversion of polarity for example, this characteristic may be used to provide an empirical adjustment to improve the amplitude correction.

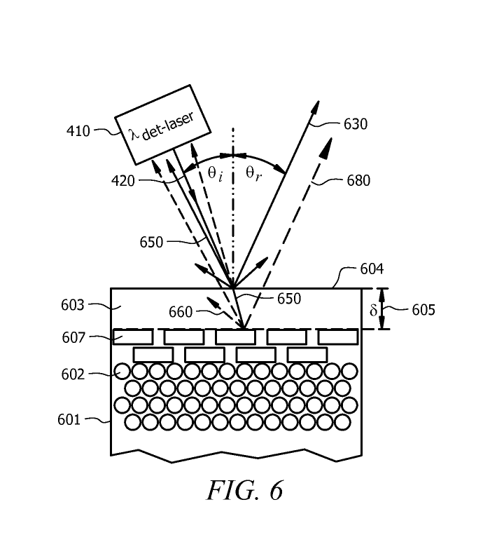

Although the examples shown in FIG. 5 demonstrate a material configuration where interior measurements would be more probable at higher angles of incidence, the opposite condition may be observed in some cases. For example, some aircraft composites have metal mesh 607 embedded inside the material as shown in FIG. 6 to reduce the effects of lightning strikes. Part 601 is composed of internal structure 602 embedded within polymer matrix 603 but metallic mesh 607 is now the structure that detection laser 420 will strike first following path 650 through top layer 605. Depending on the geometry and properties of the metal mesh, it is possible that interior reflected beam 680 may significantly exceed the intensity of surface reflection 630. Additionally, the smooth reflective nature of the metal mesh may suppress internally scattered light 660 such that high angle of incident measurements will be representative of top surface 604 while only the on-axis measurements (small θi) will be representative of the interior.

An embodiment of an improved laser ultrasound system capable of signal amplitude corrections is shown schematically in FIG. 7 as assembly 700. Generation laser 710 produces pulsed laser beam 711 that is directed to the surface of part 701 by 2D optical scanner 730. It should be appreciated that 2D optical scanner 730 could be constructed by one or two mirrors mounted on suitable rotating assemblies to direct the laser beams to the surface of part 701. Detection seed laser 720 passes through optional phase modulator 721 and detection laser amplifier 722 to produce detection laser beam 723 that is rendered substantially coaxial to beam 711 and similarly directed by 2D optical scanner 730. Both laser beams 711 and 723 will impinge on surface of part 701 at an angle of incidence denoted by θi. Optical interferometer 740 processes laser light 724 resulting from scattering or reflection of detection laser beam 723 off part 701. Interferometer 740 will produce at least a V_{dc} signal representative of the amount of light 724 collected from material 701 and an ultrasonic signal. The ultrasonic signal will be further processed by a variable gain amplifier (VGA) 750 that is controlled by processor 770 to render V_{UT}. FIG. 7 shows connections between processor 770 and some components like connection 771 to interferometer 740, connection 772 to VGA 750, and connection 773 to detection laser amplifier 722. In some implementations, other input variables may be used by processor 770 for amplitude corrections including generation laser monitor 760 via link 761 and angle of incidence data derived from 3D vision system 780. System 700 will produce ultrasonic images representative of part 701 with improved amplitude uniformity compared to previous systems that do not use adaptive amplitude correction techniques.

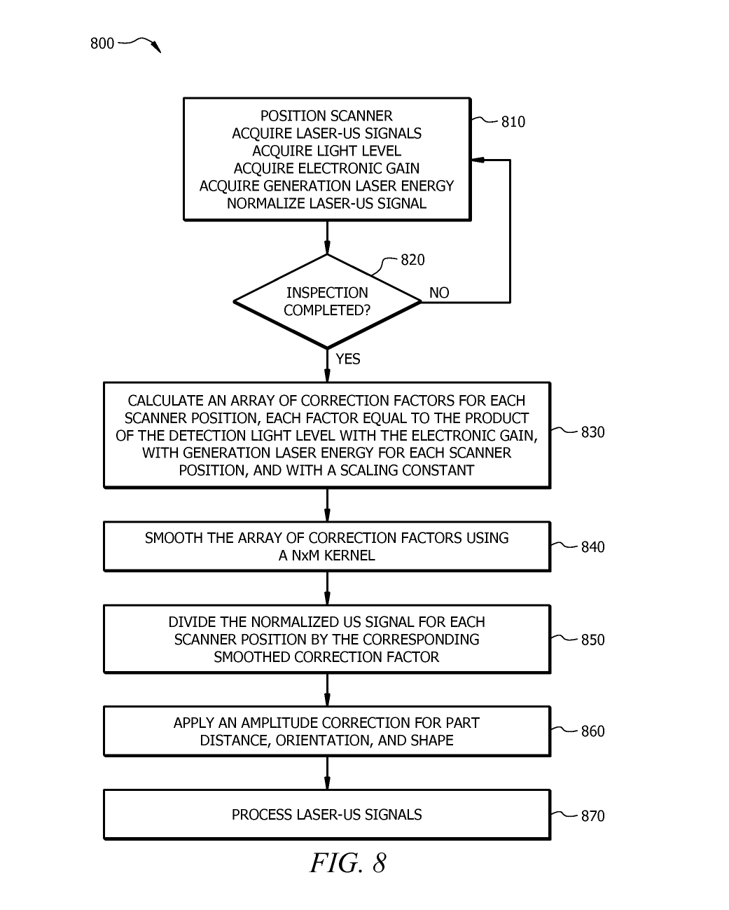

FIG. 8 illustrates an implementation of an example process 800 of acquisition of laser-ultrasonic signals from a part where a correction on the amplitude of the laser ultrasonic signals is applied to each signal. First step 810 of process 800 includes positioning the scanner to locate the laser beams at the desired location at the surface of the part, acquiring one or more laser-ultrasonic signals, acquire the detection laser light levels, acquire the electronic gain, acquire the laser energy, and normalize the laser ultrasonic signals.

The second step 820 of process 800 includes determining of the current inspection of an area of a part is completed or not. If the inspection is not completed, first step 810 is repeated.

Once the inspection is completed, step 830 includes calculating an array of correction factors for each set of laser-ultrasonic signals corresponding to each acquisition point at the surface of the sample. In the present case, each correction factor A_{corr} is equal to the product of the detection light level P_{det}, with the electronic gain G_{VGA}, with generation laser energy E_{gen-laser}, and with a scaling factor K_{scale-factor}, as illustrated in FIG. 12E.

If the generation laser pulse energy is stable over time, the generation laser energy may not be utilized to calculate the correction factor. If this approach is used, the scaling factor is modified accordingly. Assuming that the generation laser pulse energy Egen-laser is constant, the product P_{det}*G_{VGA} should be approximately constant if the effects of angle of incidence are neglected. The product P_{det}*G_{VGA} should be approximately constant because any change in light level P_{det} entails a direct change in the amplitude of the laser-ultrasonic signal. In turn, that change in signal amplitude due to the change in light level is compensated by a change in electronic gain G_{VGA} to bring back the signal to approximately the same amplitude.

However, if electronic gain G_{VGA} varies more than the changes in P_{det}, the product will be different from the constant expected in normal conditions. This change of behavior in the product P_{det}*G_{VGA} is indicative that the feature used to determine electronic gain G_{VGA} changes amplitude for reasons other than a change in detection light level P_{det}. One reason is that the location of the laser-ultrasonic measurement is now inside the top layer instead of being at the surface of the inspected part. Dividing all signals by the P_{det}*G_{VGA} product is going to reduce variations in the signal amplitudes that are caused by factors other than a change in light level. Including the generation laser pulse energy E_{gen-laser} ensures that amplitude variations due to changes in the laser pulse energy are also compensated for.

The scaling constant may be used to keep the final laser-ultrasonic signal within the range of the storage format. For example, if the laser-ultrasonic signals are stored in an unsigned 16-bit format, the scaling constant should be calculated so that the signal maxima after division by the correction factor remain below 65535 (2̂¹⁶⁻¹).

Following step 840 includes smoothing the array of correction factors using an N×M kernel. Because of experimental noise, and also because electronic gain G_{VGA} does not perfectly compensate for the detection light level variations (electronic gain may be calculated from the previously acquired signal for example), the correction factors A_{corr} for all laser-ultrasonic signals are spatially smoothed. The goal is to create an array of correction factors that represent the global spatial trend in the amplitude corrections. This smoothing may be obtained by replacing each correction factor in the array by the average of its N×M neighbors resulting in a new smoothed correction factor <A_{corr}>. For example, the correction factor at position (100, 50) in the array would be replaced by the average of all correction factors in the range (97-103, 48-52) if a 7×5 kernel is used.

This smoothing kernel also presents allows retention of the normalization of the laser-ultrasonic signal. Within the kernel, that would correspond to an area of 14 mm×10 mm in the case of a 7×5 kernel with a 2 mm distance between the acquisition points, the normalization of the laser-ultrasonic signal may facilitate identification of defects and part features in the signal amplitude.

Following step 850, as illustrated in FIG. 12F, the normalized laser-ultrasonic signal V_{UT} signal is divided by the smoothed correction factor, an example of which is illustrated in FIG. 12E.

Following step 860, an additional correction is applied to the laser-ultrasonic signal to compensate for the orientation of the part surface. The correction factors <A_{corr}> may remove and/or reduce the benefit of the normalization for angle of incidence effect. An example of a correction to apply is a division by a factor (cos θ)₂ where θ is the angle between the normal of the part surface and the generation and detection laser beams at the measurement point. The value of θ may be determined using a 3D vision system for example.

When combining the equations illustrated in FIG. 12E, equation (7) and illustrated in FIG. 12F, equation (8) together and including the division by the cos₂θ factor leads to an equation that is similar to equation (9), illustrated in FIG. 12G, that converts the acquired laser-ultrasonic signal VUIT signal into a normalized absolute signal displacement.

The absolute normalized absolute signal as given in equation (9), which is illustrated in FIG. 12G, may be utilized, in some implementations, to reduce the effects of varying amplitude of the laser-ultrasonic signal due to the measurements made below the surface. However, parameters like the actual generation laser energy density for example might not be known and may vary during the measurements. In some implementations, the use of normalization and smoothing may reduce the effects of experimental unknown parameters and experimental variations.

The final step 870 of process 800 allows analyzing laser-ultrasonic signals to produce amplitude, time-of-flight, and attenuation C-scans.

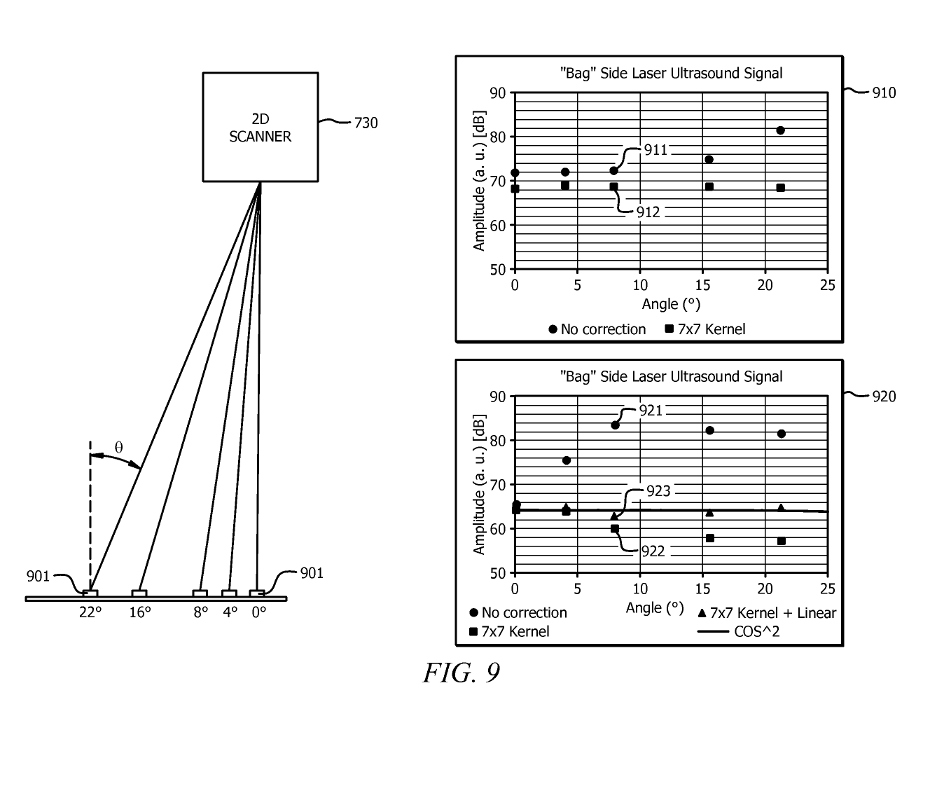

One procedure for developing and validating the amplitude correction process is to inspect a common area of a sample at various angles of incidence. Additionally the material orientation (for example the internal fiber direction) may be varied if it is suspected that the angle of incidence data could change with the material orientation. FIG. 9 shows the setup and results for evaluating a specific material at different angles of incidence when inspecting from the “bag” side and from the “tool” side. 2D optical scanner 730 inspected a small sample 901 at five different angles of incidence. The maximum 22° angle of incidence represents the extreme position along one axis of the scanner when inspecting a flat part. Higher angles of incidence may be achieved by tilting the surface of 901 to simulate larger inspection areas of complex shaped structures. In order to minimize testing variables, the exact same region of 901 is tested at each position. The data presented in chart 910 is from the optically diffuse “bag” side. Two data sets are plotted: the 911 data does not have any corrections applied and the 912 data uses the 7×7 kernel to compensate for material changes. The absolute amplitudes may be arbitrary, much like conventional ultrasound, and only variations within a data set are of significance for this analysis. The 912 data is uniform to better than 0.5 dB over the range of testing angles whereas the data without the correction kernel varies by 10 dB. The same material when tested from the tool side is plotted in graph 920. Signal amplitude 921 as a function of angle varies by almost 20 dB without the correction kernel and the rate of variation is dramatic over just a few degrees from normal. This material is representative of the structure described in FIG. 4. With the 7×7 kernel to signal amplitude 922 has a variation less than 6 dB and a linear correction for angle further reduced the variation of signal amplitude 923 to below 3 dB. As a rule of thumb, 3 dB fluctuations would fall within an allowable range for most automated defect detection procedures.

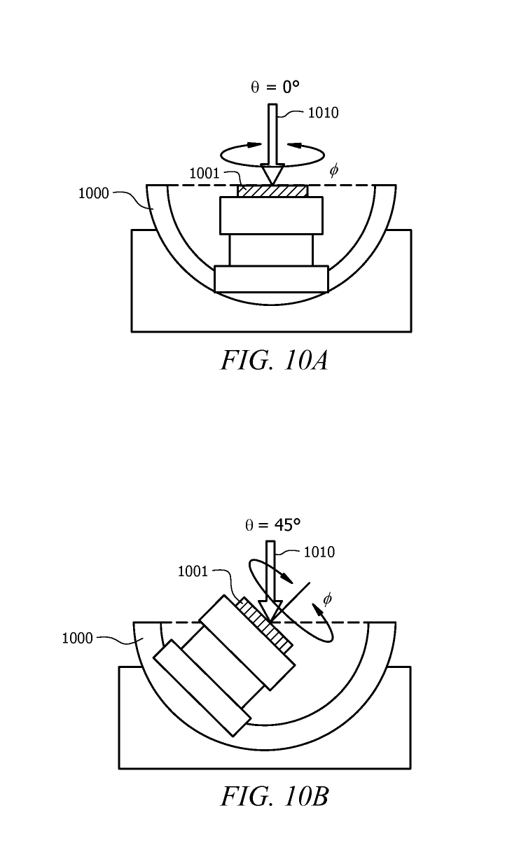

New material types and processing methods may be rigorously qualified using an assembly shown in FIG. 10A. A relatively small sample 1001 is placed on an assembly 1000 that may independently vary the incident angle θ and the part orientation φ. Laser ultrasound inspection probe 1010 may be locally scanned over the surface of 1001 to generate a statistical sampling of the material at a given orientation. Alternatively, a single data value (or a series of averages) could be obtained without scanning over the surface. For all measurements or at least a portion of the measurements, the surface of 1001 is positioned within assembly 1000 such that changing values of θ maintain the same region of 1001 exposed to laser ultrasound probe beam 1010. This is shown in FIG. 10B for an orientation where θ=45°. It is anticipated that these rigorous automated procedures would both validate the amplitude corrections process and define the boundaries of system variables such as the maximum angle of incidence.

### Example 2

As illustrated in FIG. 7, system 700 may include phase modulator 721. Phase modulator 721 may be used to add a calibration feature to the laser-ultrasonic signal. This calibration feature may be used to determine the product electronic gain by light detection level without actually measuring those parameters.

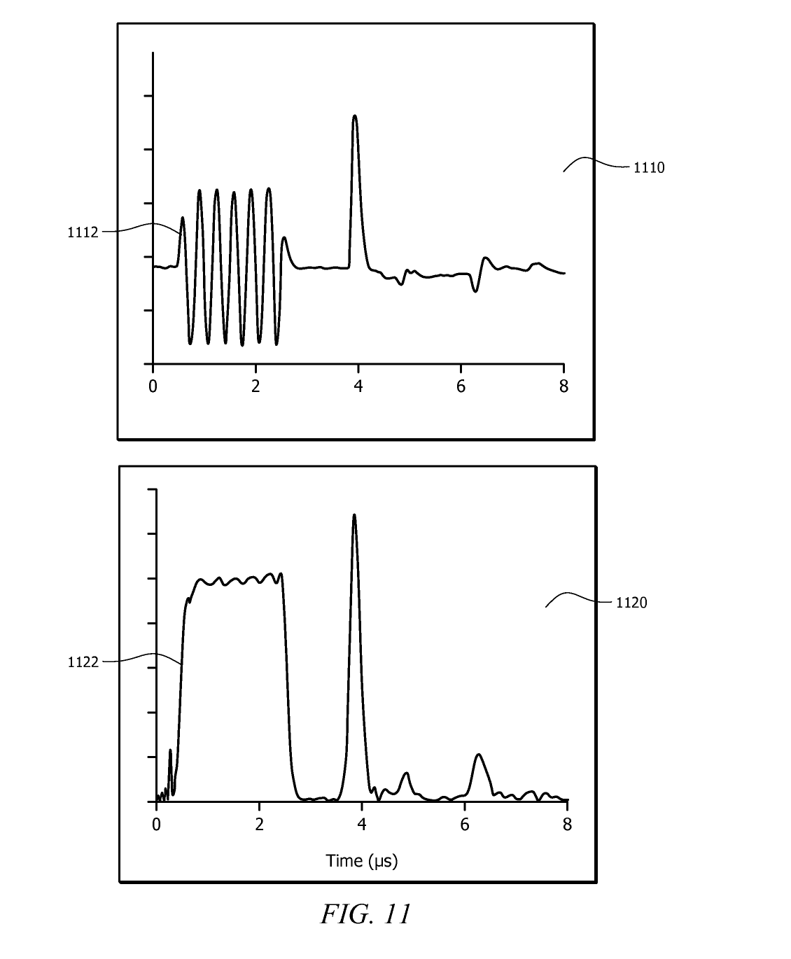

FIG. 11 shows examples of experimental signals with such a calibration feature according to an embodiment of the present disclosure. Graph 1110 shows a laser-ultrasonic signal with calibration feature 1112. Calibration feature 1112 in the present case is a 6-cycle burst at 3 MHz. In the present example, calibration feature 1112 lasts approximately 2 μs and terminates approximately 0.5 μs before the first signal echo. This may minimize and/or substantially reduce the interference of the calibration feature with the signal (e.g., associated with the laser beam applied to the material). Other approaches may be utilized that include a calibration to a laser-ultrasonic signal, as appropriate. For example, the calibration feature may be at a frequency above or below the frequency range of the laser-ultrasonic signal. The information from the calibration feature may then be separated from the laser-ultrasonic signal in the frequency domain instead of being separated in the time domain.

Knowing the excitation voltage of the phase modulator and the characteristic modulation voltage (commonly called Vπ) of the phase modulator, the amplitude of calibration feature 1112 is a direct indication of the product of light level during the measurement with the electronic gain applied to the signal. Graph 1120 shows the analytic signal calculated from the signal of graph 1112. Calibration feature 1122 of graph 1120 appears as an almost square pulse.

Utilization of a calibration signal may facilitate material testing since the electronic gain and the light level may be at a predetermined level, calibration feature 1112 may be used to determine the sensitivity of the interferometer at feature excitation frequency.

Although Examples 1 and 2 describe specific implementations of systems and processes, other implementations may be utilized as appropriate without departing from the present disclosure. One or more features of Examples 1 and/or 2 may be modified to include one or more features of other described processes, such as those described in Example 1, Example 2, system 10, system 11, process 20, process 30, and/or process 40. In addition, various features may be added, deleted, and/or modified without departing from the present disclosure.

Although users have been described as a human, a user may be a person, a group of people, a person or persons interacting with one or more computers, and/or a computer system without departing from the present disclosure.

Various implementations of the systems and techniques described here may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

In various implementations, one or more of the operations of the described processes may be performed by a computer of the laser ultrasound system and/or coupled to the laser ultrasound system. For example, one or more modules may be stored in a memory of the computer and executed by processor(s) of the computer to perform one or more of the described operations and/or processes. For example, a testing module may receive requests for testing, transmit a signal such that a laser beam and/or calibration signal is generated by the laser ultrasound system, measure one or more signals generated by the application of the laser beam to a material or portion thereof, measure one or more signals generated by the application of the control signal to the material or portions thereof, determine properties of the measured signals, apply one or more correction factors (e.g., distortion correction factor, other noise correction factors, and/or orientation correction factor), apply a smoothing kernel to the measured and/or corrected signals, determine a quality of a material based at least partially on the signals generated by the application of the laser beam to the material and/or the distortion correction factor, and/or present data measured, received, and/or determined to a user.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor. In some implementations, an article that includes a machine-readable medium stores instructions operable to cause the data processing apparatus to perform one or more of the described operations.

In various implementations, computers and/or computer systems have been described. The computers may include a server and/or a server pool. For example, a server may include a general-purpose personal computer (PC) a Macintosh, a workstation, a UNIX-based computer, a server computer, a tablet computer, a smart phone, or any other suitable device. The computer may be adapted to execute any operating system including UNIX, Linux, Windows, or any other suitable operating system. The server may include software and/or hardware in any combination suitable to provide access to data and/or translate data to an appropriate compatible format.

Although various implementations describe a single processor in the computer of the laser ultrasound system, multiple processors may be used according to particular needs, and reference to a processor is meant to include multiple processors where appropriate. The processor may include a programmable logic device, a microprocessor, or any other appropriate device for manipulating information in a logical manner.

The computer may include a memory including a repository that is a database, such as SQL databases, relational databases, object oriented databases, distributed databases, XML databases, and/or web server repositories. The memory may include one or more forms of memory such as volatile memory (e.g., RAM) or nonvolatile memory, such as read-only memory (ROM), optical memory (e.g., CD, DVD, or LD), magnetic memory (e.g., hard disk drives, floppy disk drives), NAND flash memory, NOR flash memory, electrically-erasable, programmable read-only memory (EEPROM), Ferroelectric random-access memory (FeRAM), magnetoresistive random-access memory (MRAM), non-volatile random-access memory (NVRAM), non-volatile static random-access memory (nvSRAM), and/or phase-change memory (PRAM).

To provide for interaction with a user, the systems and techniques described here may be implemented on a computer having a display device (e.g. LCD (liquid crystal display) monitor) for displaying information to the user and a keyboard and a pointing device (e.g., a mouse) by which the user may provide input to the computer. Other kinds of devices may be used to provide for interaction with a user as well; for example, feedback provided to the user by an output device may be any form of sensory feedback (e.g., visual feedback, auditory feedback, or tactile feedback); and input from the user may be received in any form, including acoustic, speech, or tactile input. In some implementations, the computer may include a touchscreen for the presentation of information and the receipt of user input.

In various implementations, a graphical user interface (GUI) may be generated by a module of the laser ultrasound system and may be displayed on a presentation interface of the computer, such as a monitor. GUI may be operable to allow the user of client to interact with repositories and/or modules of the laser detection system. Generally, GUI provides the user of client with an efficient and user-friendly presentation of data provided by the system. GUI includes a plurality of displays having interactive fields, pull-down lists, and buttons operated by the user. And in one example, GUI presents an explore-type interface and receives commands from the user. It should be understood that the term graphical user interface may be used in the singular or in the plural to describe one or more graphical user interfaces in each of the displays of a particular graphical user interface. Further, GUI contemplates any graphical user interface, such as a generic web browser, that processes information in a computer and presents the information to the user. The computer may accept data from the user via the web browser (e.g., Microsoft Internet Explorer or Google Chrome) and return the appropriate Hyper Text Markup Language (HTML) or eXtensible Markup Language (XML) responses.

It is to be understood the implementations are not limited to particular systems or processes described which may, of course, vary. It is also to be understood that the terminology used herein is for the purpose of describing particular implementations only, and is not intended to be limiting. As used in this specification, the singular forms “a”, “an” and “the” include plural referents unless the content clearly indicates otherwise. Thus, for example, reference to “a signal” may include a combination of two or more signals and reference to “a material” may include different types and/or combinations of materials.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A laser-ultrasound system comprising:
a generation laser beam that generates ultrasonic displacements in a target;
a detection laser beam that illuminates the target;
an optical and electrical assembly that collects and processes a portion of the detection laser beam that is reflected by the target to produce signals representative of mechanical displacements; and
at least one processing unit that records operational parameters during the collection and processing of the portion of the detection laser beam that is reflected by the target, calculates one or more correction factors for each signal using the recorded operational parameters, scales the amplitude of each signal using the one or more correction factors.

2. The laser-ultrasound system of claim 1 where the recorded operational parameters include the power of the portion of the detection laser beam that was collected and the electronic gain used to produce the signals.

3. The laser-ultrasound system of claim 1 where the one or more correction factors include the product of the power of the portion of the detection laser beam that was collected and the electronic gain used to produce the signals.

4. The laser-ultrasound system of claim 1 where calculating the one or more correction factors includes a smoothing by a kernel.

5. The laser-ultrasound system of claim 2 where the recorded operational parameters further include the pulse energy of the generation laser beam.

6. The laser-ultrasound system of claim 3 where the one or more correction factors further include the pulse energy of the generation laser beam.

7. The laser-ultrasound system of claim 3 where a correction as a function of the time of the signal is applied to the one or more correction factors to take into account the shape of the pulse of the detection laser beam.

8. The laser-ultrasound system of claim 3 further comprising:
a three-dimensional vision system that measures the shape of the target,
wherein the system uses the information provided by the three-dimensional vision system to apply a correction to the calculated one or more correction factors.

9. The laser-ultrasound system of claim 1 wherein the at least one processing unit comprises:
a first processing unit that records operational parameters during the collection and processing of the portion of the detection laser beam that is reflected by the target;
a second processing unit that calculates the one or more correction factors for each signal using the recorded operational parameters; and
a third processing unit that scales the amplitude of each signal using the one or more correction factors.

10. A laser-ultrasound system comprising:
a generation laser beam that generates ultrasonic displacements in a target;
a detection laser that is modulated by a phase modulator before illuminating the target;
an optical and electrical assembly that collects and processes a portion of a detection laser beam that is reflected by the target to produce signals representative of mechanical displacements; and
at least one processing unit that calculates one or more correction factors for each signal using the amplitude of the feature in the signal related to the phase modulator and scales the amplitude of each signal using the one or more correction factors.

11. The laser-ultrasound system of claim 10 further comprising:
a three-dimensional vision system that measures the shape of the target,
wherein the system uses the information provided by the three-dimensional vision system to apply a correction to the calculated one or more correction factors.

12. The laser-ultrasound system of claim 10 wherein the at least one processing unit comprises:
a first processing unit that calculates one or more correction factors for each signal using the amplitude of the feature in the signal related to the phase modulator; and
a second processing unit that scales the amplitude of each signal using the one or more correction factors.

13. A method for laser-ultrasound inspection using a laser-ultrasound system having a generation laser, a detection laser, an optical and electrical assembly, and at least one processing unit, the method comprising:
generating ultrasonic waves in a target;
illuminating the target;
collecting and processing a portion of a detection laser beam that is reflected by the target;
recording operational parameters during the collection and processing of the collected portion of the detection laser beam;
calculating one or more correction factors for each signal using the recorded operational parameters; and
scaling the amplitude of each signal using the one or more correction factors.

14. The method for laser-ultrasound inspection of claim 13 wherein the generation laser in the laser-ultrasound system performs the generating step.

15. The method for laser-ultrasound inspection of claim 13 wherein the detection laser in the laser-ultrasound system performs the illuminating step.

16. The method for laser-ultrasound inspection of claim 13 wherein the optical and electrical assembly in the laser-ultrasound system performs the collecting and processing step.

17. The method for laser-ultrasound inspection of claim 13 wherein the at least one processing unit performs the calculating and scaling steps.

18. A process for correction on an amplitude of a laser ultrasonic signal, the process comprising:
normalizing one or more laser ultrasound signals;
calculating an array of correction factors for each of the one or more laser ultrasonic signals each corresponding to each acquisition point at the surface of a part;
smoothing the array of correction factors using an N×M kernel;
dividing the normalized ultrasound signal by the corresponding smoothed correction factor; and
applying an additional correction to compensate for the orientation of the surface of the part.

19. The process of claim 18 wherein each correction factor is equal to the product of the detection light level, the electronic gain, the generation laser energy, and a scaling factor.

20. The process of claim 18 further comprising:
analyzing the laser ultrasound signal to produce amplitude, time-of-flight and attenuation C-scans.
